(19) United States
(12) Patent Application Publication
(10) Pub. No.: US 2018/0275894 A1
(43) Pub. Date: Sep. 27, 2018

(54) STORAGE SYSTEM

(71) Applicant: HITACHI, LTD., Tokyo (JP)

(72) Inventors: Yukihiro YOSHINO, Tokyo (JP); Shigeo HOMMA, Tokyo (JP); Kenta NINOSE, Tokyo (JP)

(21) Appl. No.: 15/542,446

(22) PCT Filed: Jan. 20, 2015
(86) PCT No.: PCT/JP2015/051387

§ 371 Date: Jul. 10, 2017

(51) Int. Cl. G06F 3/06; G06F 11/07

(52) U.S. Cl. CPC G06F 3/0616; G06F 3/0647; G06F 11/076; G06F 11/0727; G06F 3/0689

(57) ABSTRACT

According to one aspect of the present invention, the storage system has a storage controller and a plurality of storage devices. Each storage device calculates its degradation level based on an error bit count (number of correctable errors that have occurred during read), and transmits the same to the storage controller. By calculating the life of each RAID group based on the received degradation levels of the respective storage devices, the storage controller specifies the RAID group predicted to reach its life before achieving a target service life (target life), and migrates the data stored in the specified RAID group to a different RAID group.

### TECHNICAL FIELD

The present invention relates to a storage system using nonvolatile semiconductor memories.

### BACKGROUND ART

Nonvolatile semiconductor memories, such as NAND-type flash memories, are power efficient and has higher performance compared to magnetic storage devices such as HDDs, but they are also expensive. However, the costs thereof are decreasing, along with the advancement of semiconductor technology, and so they are now attracting attention as main stream storage devices that may replace HDDs.

Storage apparatuses using flash memories (flash storages) have a characteristic feature in that the possible number of rewrites (number of erases) is limited. Therefore, if there are frequent rewrites to a specific storage area, the life of that area may end at an early stage (the area cannot be accessed), and as a result, the flash storage itself can no longer be used.

In order to solve this problem, for example, Patent Literature 1 teaches controlling the data storage location so that the number of erases of each storage area in nonvolatile semiconductor devices such as SSDs is leveled. Patent Literature 1 further discloses, in a storage apparatus having a plurality of SSDs installed therein, leveling the number of erases among SSDs by exchanging storage data between the SSD having a short remaining life and the SSD having a long remaining life to level the number of erases, wherein the remaining life is a value calculated based on a speed of reduction of the remaining number of erases.

### CITATION LIST

### Patent Literature

[PTL 1] US Patent Application Publication No. 2013/0205070

### SUMMARY OF INVENTION

### Technical Problem

The system taught in Patent Literature 1 is designed based on the assumption that the remaining life of each storage device is the same if the number of erases (or the number of writes) is the same. If this assumption holds true, the method taught in Patent Literature 1 prevents a storage device from becoming unusable alone at an early stage. As a result, each storage media installed in the storage apparatus can maintain a usable state throughout a term (service life) assumed in advance.

However, in reality, the qualities of each of the storage media are not uniform, so that even if control is performed to substantially equalize the number of erases of the respective storage media, a case may occur where a certain storage media is in an accessible state (has not reached its life) but another storage media is in an inaccessible state (has reached its life). Therefore, actually, it is difficult to use every storage media until it reaches its service life by merely controlling the number of erases.

### Solution to Problem

According to one aspect of the invention, the storage system has a storage controller and multiple storage devices. Each storage device computes its degradation level based on an error bit count (the number of correctable errors that have occurred during data read), and transmits it to the storage controller. The storage controller calculates the life of each RAID group based on the received degradation level of the storage device, to specify the RAID group predicted to reach its life before reaching its target service life (target life), and migrates the data stored in the specified RAID group to a different RAID group.

### Advantageous Effects of Invention

According to the present invention, the life of the respective storage media can be leveled, and the use thereof to their respective service life can be assured.

### BRIEF DESCRIPTION OF DRAWINGS

FIG. 1 is a hardware configuration diagram of a computer system according to a preferred embodiment of the present invention.

FIG. 2 is a configuration diagram of an FMPK.

FIG. 3 is an explanatory view of a RAID group.

FIG. 4 is a view showing a relationship between virtual volumes, RAID groups and pools.

FIG. 5 is a view showing the contents of programs and management information stored in a memory of a storage controller.

FIG. 6 is a view illustrating a configuration of a virtual volume management table.

FIG. 7 is a view illustrating a configuration of a pool management table.

FIG. 8 is a view illustrating a configuration of a RAID group management table.

FIG. 9 is a view illustrating the contents of programs and management information stored in a memory of an FMPK controller.

FIG. 10 is a view illustrating a configuration of a logical-physical conversion table.

FIG. 11 is a view illustrating a configuration of a block management table.

FIG. 12 is a view illustrating a relationship between interval after WR and error bit count.

FIG. 13 is a view illustrating a configuration of an error bit count threshold management table.

FIG. 14 is a flowchart of an inspection processing.

FIG. 15 is a flowchart of a write processing.

FIG. 16 is a flowchart of a life prediction processing.

FIG. 17 is a flowchart of a RAID group operation information acquisition processing.

FIG. 18 is a flowchart of an operation information tabulation processing.

FIG. 19 is a flowchart of a RAID group life prediction processing.

FIG. 20 is a flowchart of a chunk migration amount calculation processing.

FIG. 21 is a flowchart of a RAID-group-to-RAID-group chunk migration processing.

FIG. 22 is a flowchart of a chunk migration processing.

FIG. 23 is an explanatory view of the relationship between amount of write data and life ratio.

FIG. 24 is an explanatory view of the relationship between operating time and amount of write of RAID group.

### DESCRIPTION OF EMBODIMENTS

Now, the preferred embodiments of the present invention will be described with reference to the drawings. The preferred embodiments illustrated below are not intended to restrict the scope of the invention disclosed in the claims, and not all the described components and combinations thereof described in the preferred embodiments are indispensable as the means for solving the problems of the present invention.

In the following description, various information are referred to as “aaa tables”, for example, but the various information can also be expressed by data structures other than tables. The “aaa table” and the like can also be referred to as “aaa information” to show that the information does not depend on the data structure. Further, information for identifying “bbb” of the present invention can be described using a term “bbb name”, for example, but such identification information is not restricted to names, and can also be an identifier, an identification number or an address.

The processes are sometimes described using the term “program” as the subject, but the program is actually executed by a processor (CPU (Central Processing Unit)) performing predetermined processes using a memory and I/Fs (interfaces). In order to prevent lengthy description, the program may be described as the subject. A portion or all of the programs can be realized by a dedicated hardware. The various programs can be installed to each computer from a program distribution server or a computer-readable storage media, for example. The storage media can be IC cards, SD cards, DVDs and the like.

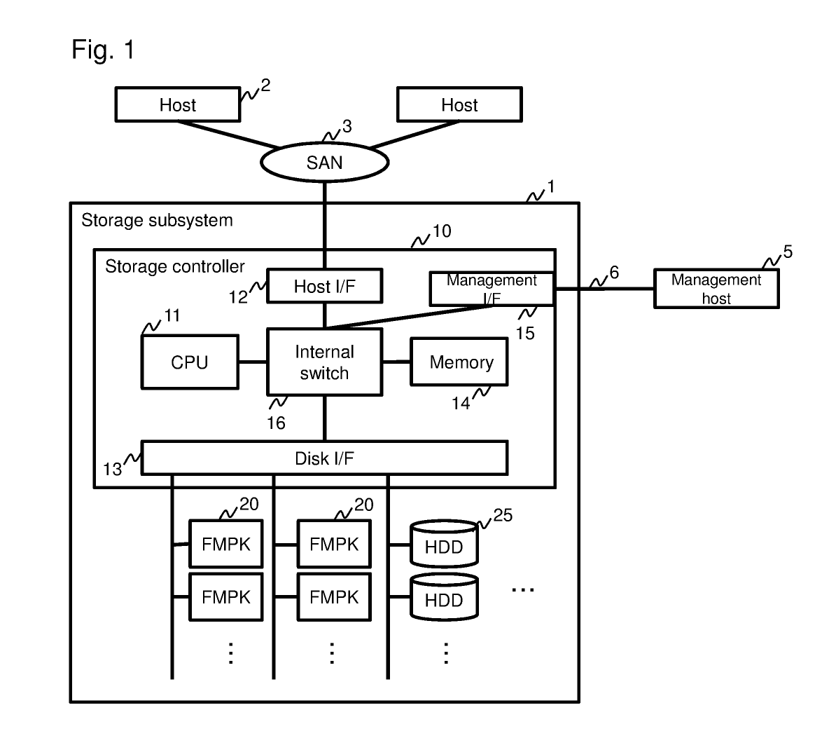

FIG. 1 is a view showing a configuration of a storage apparatus (storage system) 1 according to a preferred embodiment of the present invention. The storage apparatus 1 has a storage controller 10, and a plurality of flash packages (FMPKs) 20 connected to the storage controller 10.

The FMPK 20 is a storage device for storing write data from a host 2 or other superior devices, and it is a storage device adopting a nonvolatile semiconductor memory such as a flash memory as the storage media. The internal configuration of each FMPK 20 will be described later. As an example, each FMPK 20 is connected to the storage controller 10 via a transmission line (SAS link) in compliance with SAS (Serial Attached SCSI) standards.

Further, as illustrated in FIG. 1, HDD (Hard Disk Drives) 25 can also be installed to the storage apparatus 1 of the present embodiment, in addition to the FMPK 20. The HDDs 25 are storage devices having magnetic disks as the storage media. The HDDs 25 are connected to the storage controller 10, similar to the FMPK 20. Similar to the FMPK 20, the HDD 25 is also connected via an SAS link to the storage controller 10. In the following description, we will mainly describe a configuration where only FMPKs 20 are connected as storage devices to the storage apparatus 1 of the present embodiment.

The storage controller 10 has one or more hosts 2 connected thereto. Further, the storage controller 10 has a management host 5 connected thereto. The storage controller 10 and the host 2 are connected via a SAN (Storage Area Network) 3 formed using a Fibre Channel, as an example. The storage controller 10 and the management host 5 are connected via a LAN (Local Area Network) 6 formed using an Ethernet, as an example.

The storage controller 10 includes at least a processor (CPU) 11, a host interface (referred to as “host I/F” in the drawing) 12, a disk interface (referred to as “disk I/F” in the drawing) 13, a memory 14, and a management I/F 15. The processor 11, the host I/F 12, the disk I/F 13, the memory 14 and the management I/F 15 are mutually connected via an internal switch (internal SW) 16. There is only one each of these components illustrated in FIG. 1, but in order to ensure high performance and high availability, a plurality of the respective components can be installed in the storage controller 10. A configuration can be adopted where the respective components are mutually connected via a common bus, instead of via the internal SW 16.

The disk I/F 13 has, at least, an interface controller and a transfer circuit. The interface controller is a component for converting the protocol used by the FMPK 20 (one example of which is the SAS) into a communication protocol used within the storage controller 10 (one example of which is a PCI-Express). The transfer circuit is used when the storage controller 10 performs data transfer (read or write) to the FMPK 20.

The host I/F 12 includes at least an interface controller and a transfer circuit, similar to the disk I/F 13. The interface controller equipped to the host I/F 12 is for converting a communication protocol used in the data transfer path between the host 2 and the storage controller 10 (such as the Fibre Channel) and a communication protocol used within the storage controller 10.

The processor 11 performs various control of the storage apparatus 1. The memory 14 is used to store programs executed by the processor 11 and various management information of the storage apparatus 1 used by the processor 11. The memory 14 is also used to temporarily store I/O target data to the FMPK 20. Hereafter, the storage area within the memory 14 used to temporarily store the I/O target data with respect to the FMPK 20 is called “cache”. The memory 14 is configured of a volatile storage media such as a DRAM or an SRAM, but as a different embodiment, the memory 14 can be configured using a nonvolatile memory.

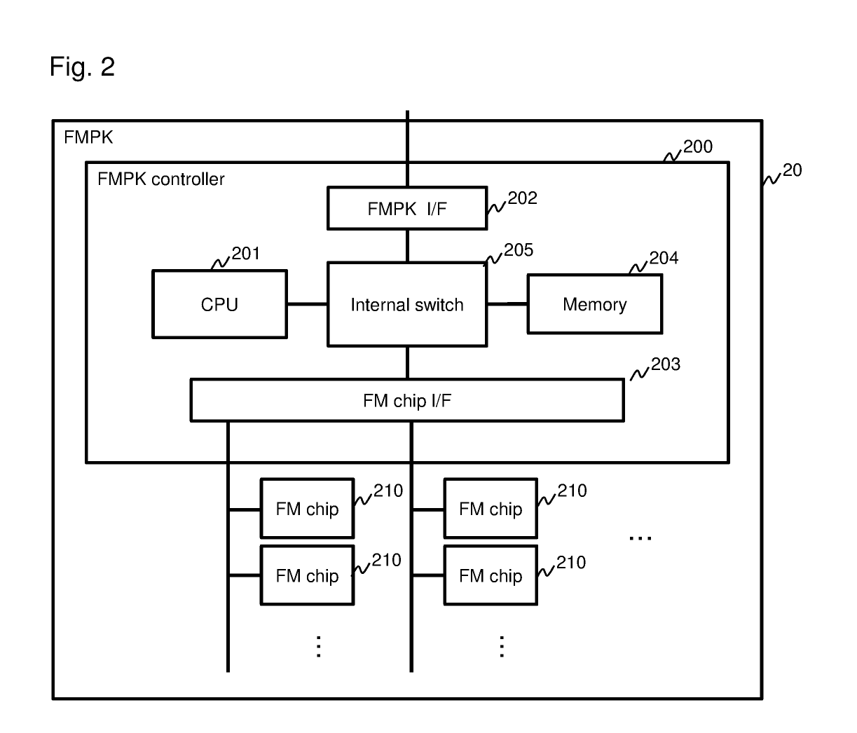

The configuration of an FMPK 20 will be described with reference to FIG. 2. The FMPK 20 is composed of an FMPK controller 200 and a plurality of FM chips 210. The FMPK controller 200 includes a processor (CPU) 201, an FMPK I/F 202, an FM chip I/F 203, and a memory 204, which are mutually connected via an internal connection switch (internal connection SW) 208.

The FMPK I/F 202 is an interface controller for realizing communication between the FMPK 20 and the storage controller 10. The FMPK I/F 202 is connected to the disk I/F 13 of the storage controller 10 via a transmission line (SAS link). On the other hand, the FM chip I/F 203 is an interface controller for realizing communication between the FMPK controller 200 and the FM chips 210.

Further, the FM chip I/F 203 has a function to generate ECC (Error Correcting Code), to detect error using the ECC, and to correct the error. When data is transmitted (written) from the FMPK controller 200 to the FM chips 210, the FM chip I/F 203 generates an ECC. Then, the FM chip I/F 203 adds the generated ECC to the data, and the ECC-added data is written to the FM chips 210. When the FMPK controller 200 reads data from the FM chips 210, the ECC-added data is read out from the FM chips 210, and this ECC-added data reaches the FM chip I/F 203. The FM chip I/F 203 performs a data error check using the ECC (ECC is generated based on the data, and whether the generated ECC corresponds to the ECC added to the data or not is checked), and when data error is detected, data correction is performed using the ECC. Further, the FM chip I/F 203 also has a function to notify to the CPU 201 the number of errors that have occurred when data error occurs.

The CPU 201 performs processes related to respective commands having arrived from the storage controller 10. The memory 204 stores programs to be executed by a processor 201 and various management information. DRAMs or other volatile memories are used as the memory 204. However, it is also possible to use a nonvolatile memory as the memory 204.

The FM chips 210 are, for example, nonvolatile semiconductor memory chips such as NAND type flash memories. As known, in flash memories, reading and/or writing data is done in a page-by-page basis, and further, data erase is performed in a block-by-block basis, each block being an assembly of a plurality of pages. The page where data has been written once cannot be overwritten, so that in order to perform rewrite to a page where data has been written once, the whole block including the page must be erased.

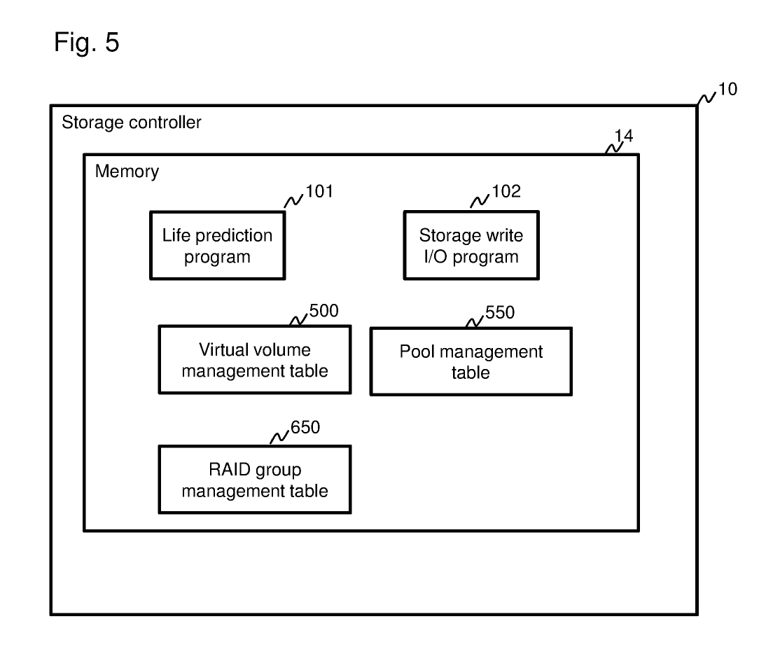

Next, we will describe the programs and management information that are required to execute the processes described in the storage apparatus 1 according to the present invention. As shown in FIG. 5, the memory 14 of the storage controller 10 includes at least a life prediction program 101, a storage write I/O program 102, a virtual volume management table 500, a pool management table 550, and a RAID group management table 650. The contents of these programs and management tables will be described below.

Before describing the above contents, we will describe the concept related to the storage area used in the storage apparatus 1. The storage apparatus 1 manages a plurality of FMPKs 20 as a RAID (Redundant Arrays of Inexpensive/Independent Disks) group. When failure occurs to one (or two) FMPK(s) 20 within the RAID group and data cannot be accessed, data stored in the FMPK 20 where failure has occurred can be rebuilt from data stored in the remaining FMPKs 20.

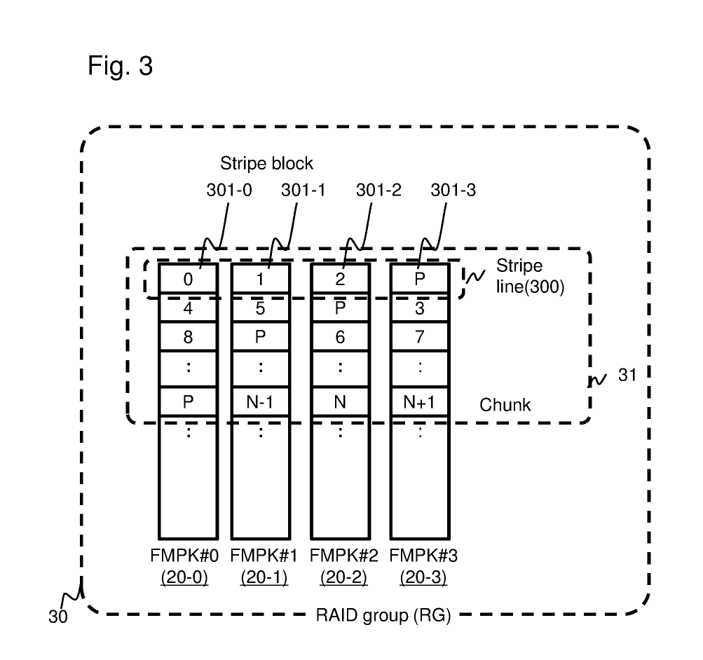

The storage area within the RAID group will be described with reference to FIG. 3. In FIG. 3, each of the FMPK #0 (20-0) through FMPK #3 (20-3) represents storage space that the FMPK 20 provides for the storage controller 10. The storage controller 10 constitutes one RAID group 30 from a plurality of (four, in the example of FIG. 3) FMPKs 20, and the storage space in each FMPK (FMPK #0 (20-0) through FMPK #3 (20-3)) belonging to the RAID group 30 is divided into a plurality of fixed-size storage areas called stripe blocks (301) for management.

FIG. 3 illustrates an example of a case where the RAID level of the RAID group 30 (showing the data redundancy method in a RAID technique, and in general, the RAID levels are from RAID 1 to RAID 6) is RAID 5. In FIG. 3, boxes denoted by “0”, “1”, “P” and so on in the RAID group 20 represent stripe blocks, wherein the size of each stripe block is, for example, 64 KB, 256 KB, or 512 KB. The numeric value such as “1” assigned to each stripe block is called a “stripe block number”.

In FIG. 3, the stripe block denoted by the letter “P” of the stripe blocks is a stripe block in which redundant data (parity) is stored, and this block is called a “parity stripe”. On the other hand, the stripe blocks denoted by numbers (such as 0 or 1) are stripe blocks having data (which is not a redundant data) written from superior devices such as the host 2. This stripe block is called a “data stripe”.

In the RAID group 30 illustrated in FIG. 3, for example, the stripe block positioned at the beginning of FMPK #3 (20-3) is the parity stripe 301-3. When the storage controller 10 creates redundant data to be stored in the parity stripe 301-3, a predetermined operation (such as an exclusive OR (XOR)) is performed to the data stored in the data stripes (stripe blocks 301-0, 301-1 and 301-2) positioned at the beginning of each FMPK 20 (FMPK #0 (20-0) through FMPK #2 (20-2)), so as to generate the redundant data.

Hereafter, the set of the parity stripe and the data stripes used to generate the redundant data to be stored in the relevant parity stripe (such as element 300 of FIG. 3) is called a “stripe line”. In the storage apparatus 1 according to the present embodiment, a stripe line is configured based on a rule where each stripe block belonging to one stripe line is positioned at the same position (address) within the storage space on each of the FMPKs 20-0 through 20-3, as shown by the stripe line 300 of FIG. 3.

The storage controller 10 manages the plurality of stripe lines located continuously within the RAID group by units called “chunks”. As shown in FIG. 3, a chunk 31 includes a plurality of stripe lines. However, it is also possible to adopt a configuration where one chunk 31 only includes one stripe line.

Further, the storage controller 10 provides one or more virtual storage spaces that differ from the storage area of the RAID group to the host 2. This virtual storage space is called a “virtual volume”. The storage space of the virtual volume is also managed by being divided into areas having predetermined sizes. These areas having predetermined sizes are called “virtual chunks”. Virtual chunks are allocation units of the storage area of the FMPK 20.

One chunk is mapped to one virtual chunk, and when data write occurs from the host 2 to the virtual chunk, the data is stored in the mapped chunk. However, when a chunk is mapped to a virtual chunk, only the data stripes within the chunk are mapped. Therefore, the size of the virtual chunk is equal to the total size of all data stripes included in the chunk. The storage controller 10 manages the storage area (chunk) allocated to the virtual chunk by recording the mapping of the virtual chunks and the chunks in the virtual volume management table 500 described later.

A chunk is not mapped to each virtual chunk of the virtual volume immediately after the virtual volume is defined. Only after the write request to the area in the virtual chunk is received from the host 2, the storage controller 10 determines the storage area (chunk) in the FMPK 20 to which data should be written. Regarding the chunk determined here, one chunk is determined from chunks which are not yet allocated to any virtual chunks (unused chunk).

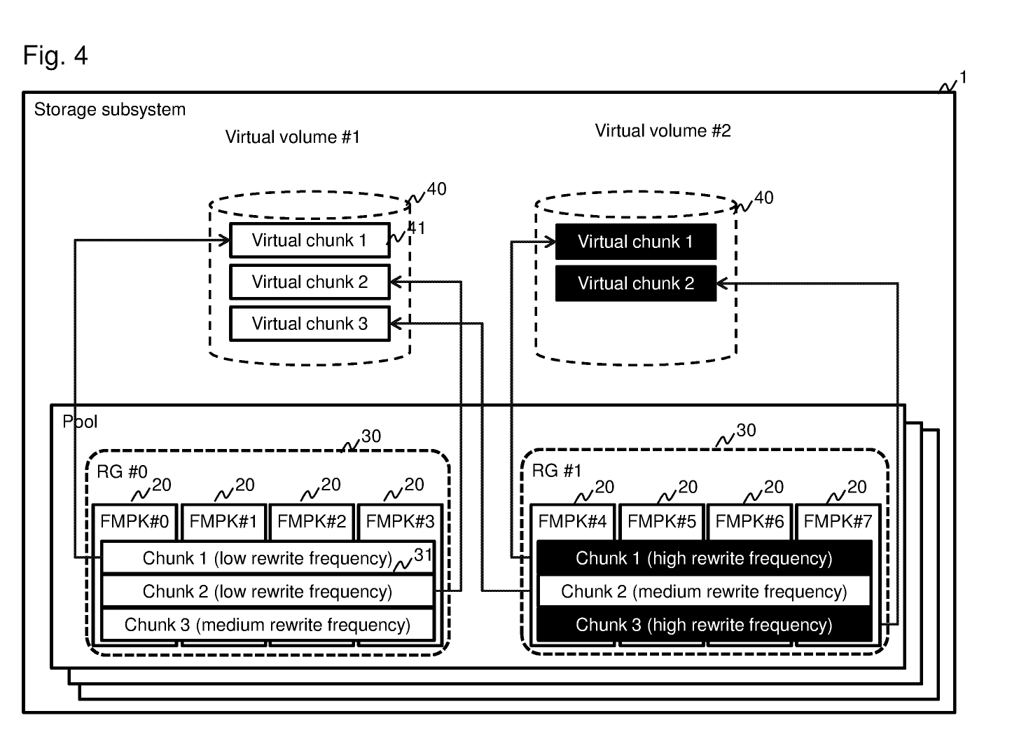

In the storage apparatus 1 according to the present embodiment, there is a certain limitation to the chunk capable of being allocated to a virtual chunk of a certain virtual volume. The one or more RAID groups having storage areas (chunks) capable of being allocated to the virtual chunks are managed in management units called pool. FIG. 4 shows a relationship between pool, RAID group 30 and virtual volume 40. The storage apparatus 1 is capable of managing one or more pools, and when the storage apparatus 1 manages multiple pools, the one or more RAID groups having storage areas capable of being allocated to virtual chunks are managed by one of the plurality of pools. Hereafter, a RAID group managed by a certain pool (provisionally called pool X) (and chunks within the RAID group) is called “RAID group (or chunks) belonging to pool X”. Further, when a chunk is allocated to (virtual chunks of) each virtual volume, one pool to which the allocatable chunks belong is set in advance for each virtual volume.

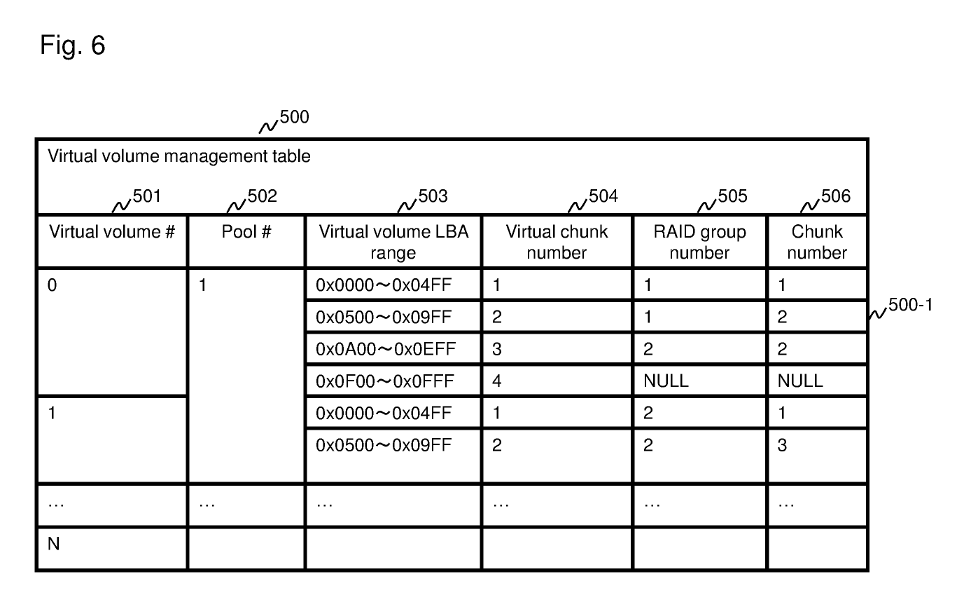

The contents of the virtual volume management table 500 will be described with reference to FIG. 6. As described earlier, the virtual volume management table 500 is a table for managing the mapping relationship between the virtual chunks within the respective virtual volumes defined within the storage apparatus 1 and the chunks. The virtual volume management table 500 includes columns of a virtual volume #501, a pool #502, a virtual volume LBA range 503, a virtual chunk number 504, a RAID group number 505, and a chunk number 506. Each row (record) of the virtual volume management table 500 shows that a chunk specified by the RAID group number 505 and the chunk number 506 are mapped to the virtual chunk specified by the virtual volume #501 and the virtual chunk number 504. In the following description, the respective rows of the table managing the respective information are called “records”, not restricted to the virtual volume management table 500.

In the initial state, chunks are not mapped to virtual chunks. A chunk is mapped to a virtual chunk at the point of time when a write request to the virtual chunk is received from the host 2. If a chunk is not mapped to the virtual chunk specified by the virtual chunk number 504, an invalid value (NULL) is stored in the RAID group number 505 and the chunk number 506 of the relevant record.

Further, an identification number of the pool to which a chunk capable of being allocated to the virtual volume belongs is stored in the pool #502. That is, the chunk capable of being allocated to the virtual chunk of the virtual volume specified by the virtual volume #501 is fundamentally restricted to the chunk (or RAID group) belonging to the pool #502. The virtual volume LBA range 503 is information showing which virtual chunk specified by the virtual chunk number 504 corresponds to which area in the virtual volume. As an example, in row (record) 500-1 of FIG. 6, the virtual volume LBA range 503 is “0x0500-0x09FF” and the virtual chunk number 504 is “2”, indicating that the virtual chunk 2 of virtual volume #0 corresponds to the areas whose LBA is from 0x0500 to 0x09FF in the virtual volume #0.

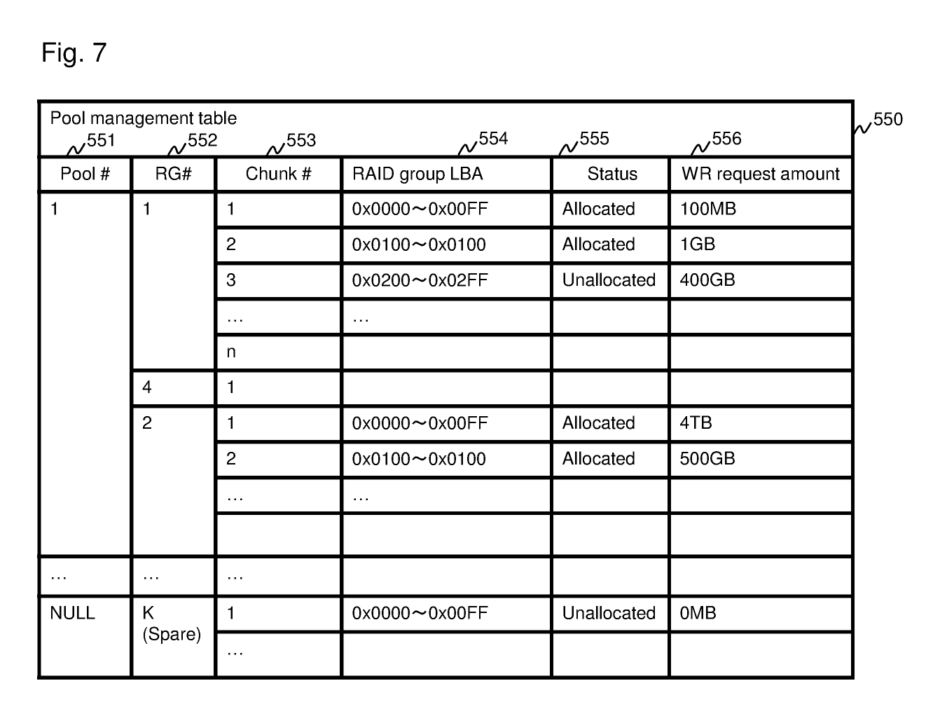

The pool is managed by the pool management table 550. The contents of the pool management table 550 will be described with reference to FIG. 7. The pool management table 550 includes columns of a pool #551, an RG #552, a chunk #553, a RAID group LBA 554, a status 555, and a WR request amount 556. In the pool management table 550, each record stores information related to the chunk. The RG #552 of each record shows the RAID group number of the RAID group to which the chunk belongs, and the pool #551 shows the pool number of the pool to which the chunk belongs. Further, the pool #551 shows the pool number to which the RAID group specified by the RG #552 belongs.

Further, the RAID group LBA 554 of each record is the information showing that in which region in the RAID group the chunk is located. The status 555 is information showing whether a chunk is allocated (mapped) to a virtual chunk or not. If “allocated” is stored in the status 555, it means that the chunk is allocated to the virtual chunk. In contrast, if “unallocated” is stored in the status 555, it means that the chunk is not allocated to the virtual chunk. The WR request amount 556 shows the total amount of data that the storage controller 10 has written to the chunk. When the storage controller 10 writes data to the chunk, it also writes data to the parity stripe. Therefore, the WR request amount 556 also includes the amount of information (parity) written to the parity stripe.

As described, according to the storage apparatus 1 of the present embodiment, the chunk (and the RAID group having that chunk) mapped to the virtual chunk of the virtual volume must belong to the pool to which the virtual volume has been registered. However, the storage apparatus 1 according to the present invention is also capable of having a RAID group that does not belong to the pool. This RAID group is called a spare RAID group.

The storage apparatus 1 also manages the spare RAID group using the pool management table 550. In the storage apparatus 1 according to the present embodiment, the spare RAID group is managed in a state belonging to a pool whose pool #551 is NULL (invalid value) for convenience. In FIG. 7, the RAID group whose RG #552 is K exists in the pool whose pool #551 is NULL (invalid value). This RAID group is the spare RAID group.

The chunk of the spare RAID group may be used as a result of executing a chunk migration processing described later. The details will be described later, but by the chunk migration processing, if an appropriate migration destination of the chunk does not exist within the pool, (the data stored in) the chunk may be migrated to a chunk within the spare RAID group, as exceptional measures.

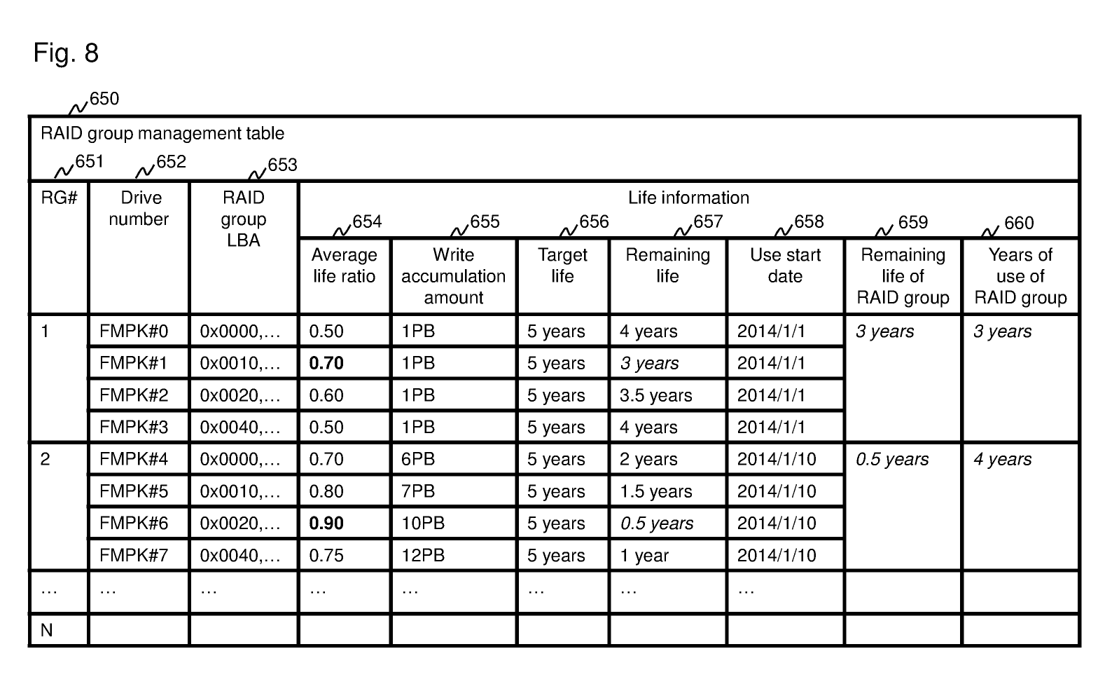

In the storage apparatus 1 according to the present embodiment, the number of occurrence of errors of the FMPK 20 and the amount of write requests are collected, and these information are used to perform life management of the FMPK 20 and the RAID group. There is a table for managing information collected from the FMPK 20 and the like. This table is called a RAID group management table 650. The contents of the RAID group management table 650 will be described with reference to FIG. 8.

The RAID group management table 650 includes columns of an RG #651, a drive number 652, a RAID group LBA 653, an average life ratio 654, a write accumulation amount 655 (also referred to as WR accumulation amount 655), a target life 656, a remaining life 657, a use start date 658, a remaining life of RAID group 659, and years of use of RAID group 660. A RAID group number of the RAID group is stored in the RG #651, and the identifier of the FMPK 20 belonging to the RAID group specified by the RG #651 is stored in the drive number 652. The RAID group LBA 653 is information showing which area of the RAID group to which each area of the FMPK 20 specified by the drive number 652 is positioned.

The average life ratio 654, the WR accumulation amount 655, the target life 656, the remaining life 657, the use start date 658, the remaining life of RAID group 659 and the years of use of RAID group 660 are information collectively referred to as “life information”. The storage apparatus 1 uses these life information to perform life management.

The average life ratio 654 is a value calculated based on the number of occurrence of errors (correctable errors) having occurred in the FMPK 20, the details of which will be described later. The storage controller 10 acquires this information from the FMPK 20. The WR accumulation amount 655 is the total amount of data having been written to the storage area (physical page of the FM chip 210) of the FMPK 20. The storage controller 10 also acquires this information from the FMPK 20.

The target life 656 is a column storing a target service life of the FMPK 20. Normally, each FMPK 20 has its target service life (number of years, such as five years) determined in advance by the manufacturer of the FMPK 20 (or the storage apparatus 1). The administrator of the storage apparatus 1 stores the target service life set for the FMPK 20 in the column of the target life 656 when defining the RAID group. However, it is possible to have the storage apparatus 1 automatically set the target service life in the target life 656.

The remaining life 657 is a column for storing the remaining life (predicted value) of the FMPK 20. The storage controller 10 calculates this remaining life (predicted value) based on the average life ratio 654 and the WR accumulation amount 655, and stores the same in the remaining life 657. The method for calculating the remaining life (predicted value) and the like will be described later.

The use start date 658 is a column storing the date (year, month, and day) when the use of the FMPK 20 was started. The storage apparatus 1 according to the present embodiment determines that the use is started when the FMPK 20 is installed in the storage apparatus 1. Therefore, the date in which the FMPK 20 was installed in the storage apparatus 1 is stored in the use start date 658. The remaining life of RAID group 659 is a value calculated by the storage controller 10 based on the remaining life 657. The details thereof will be described later. The years of use of RAID group 660 is a value calculated by the storage controller 10 based on the use start date 658. The details thereof will be described later.

The RAID group management table 650 can also include information other than those described above. For example, information related to the RAID configuration of the RAID group (such as the number of FMPKs 20 configuring the RAID group, the RAID level and the like) can be stored. Further, in order to facilitate description of the present embodiment, the number of FMPKs 20 configuring the RAID group and the RAID level are set to be the same for all RAID groups.

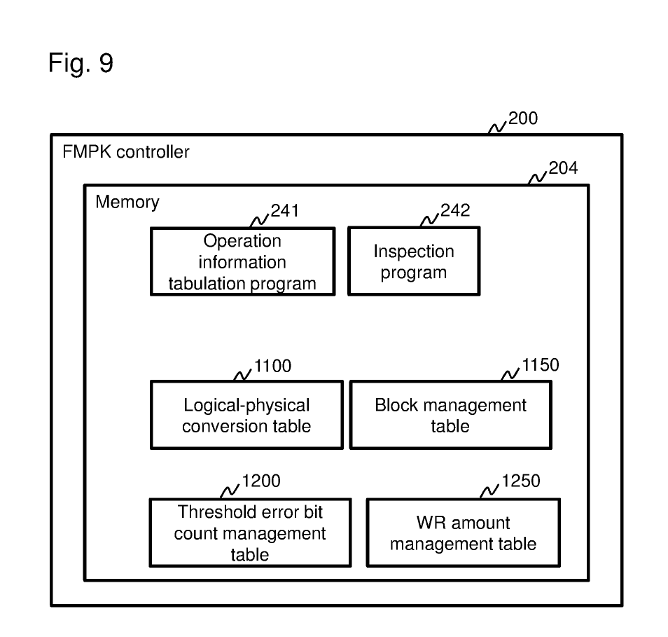

Next, the information managed by the FMPK 20 and the programs executed by the FMPK 20 will be described with reference to FIG. 9. At least two programs, which are an operation information tabulation program 241 and an inspection program 242, are stored in the memory 204 of the FMPK 20. Further, a logical-physical conversion table 1100, a block management table 1150, a threshold error bit count management table 1200 and a WR amount management table 1250 are stored.

The logical-physical conversion table 1100 is a table for managing the mapping between the logical page and physical page managed by the FMPK 20. The FMPK 20 adopts a flash memory as the storage media. As known, the minimum access (read/write) unit of the flash memory (FM chip 210) is a page (physical page). The size of the physical page is, for example, 8 KB. Therefore, the FMPK 20 divides the storage space that the FMPK 20 provides to the storage controller 10 into areas having the same size as the physical page. The area having the same size as the physical page is called a “logical page”. Then, the FMPK 20 maps a single physical page to a single logical page.

The FMPK 20 according to the present embodiment has multiple FM chips 210. Each FM chip 210 has a plurality of physical blocks which are data erase units. Each physical block includes a plurality of physical pages. The FMPK 20 according to the present embodiment assigns an identification number unique within the FMPK 20 to the respective physical blocks in all the FM chips 210, and this identification number is called a block number (block #). Each page within the physical block is managed by assigning a number unique within the physical block, and this number is called a page number (or a physical page #). The physical page within the FMPK 20 is uniquely specified by specifying the block # and the physical page #.

Further, the FMPK 20 according to the present embodiment assigns an identification number unique within the FMPK to each logical page within the FMPK 20 for management. This identification number is called a logical page number (logical page #). The block # and physical page # information of a physical page mapped to a logical page is stored for each logical page in the logical-physical conversion table 1100.

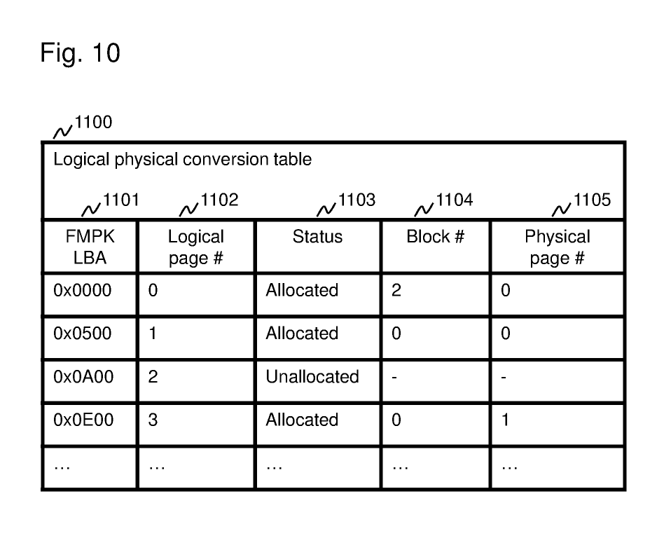

As shown in FIG. 10, the logical-physical conversion table 1100 includes columns of an FMPK LBA 1101, a logical page #1102, a status 1103, a block # 1104, and a physical page #1105. Information related to a logical page specified by the logical page #1102 is stored in each record of the logical-physical conversion table 1100. The LBA (LBA range) within the storage space that the FMPK 20 provides to the storage controller 10 is stored in the FMPK LBA 1101. When the FMPK 20 receives an access request from the storage controller 10, the FMPK 20 uses the FMPK LBA 1101 and the logical page #1102 to convert the LBA included in the access request to the logical page #. Further, information for specifying the physical page to be mapped to the logical page (that is, the block # and the physical page #) is stored in the block #1104 and the physical page #1105, respectively.

Information showing whether a physical page is mapped to a logical page or not is stored in the status 1103. In the initial state, a physical page is not mapped to the logical page of the FMPK 20. At the point of time when a write request is received from the storage controller 10, a physical page is mapped to the logical page being the write target based on the write request. When “allocated” is stored in the status 1103, it shows that a physical page is mapped to a logical page. In contrast, when “unallocated” is stored in the status 1103, it means that a physical page is not mapped to the logical page (at this time, NULL (invalid value) is stored in the block #1104 and the physical page #1105 corresponding to this logical page).

As well known, a physical page which had once been written cannot be overwritten (before overwriting the physical page, the whole physical block to which the physical page belongs must be erased once). Therefore, when an update (overwrite) request to a certain logical page is received from the storage controller 10, the FMPK 20 stores the update data in a physical page (called a new physical page) that differs from the physical page to which the data before update (called an old physical page) is stored. Then, the block # and the physical page # of the new physical page is stored in the block #1104 and the physical page #1105 corresponding to the logical page being the target of update.

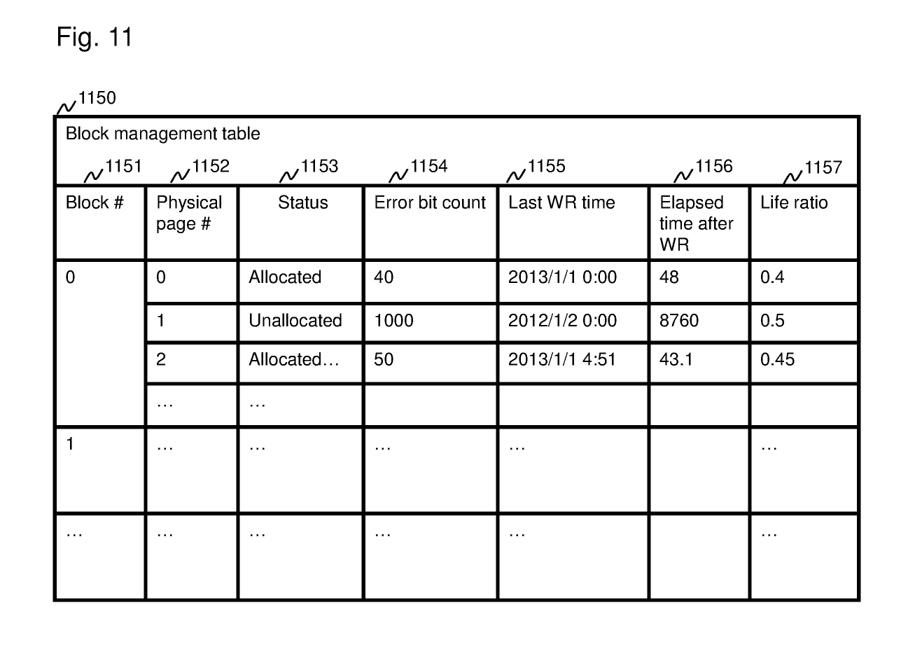

On the other hand, the block management table 1150 is a table for managing the states of the physical block/physical page. The block management table 1150 will be described with reference to FIG. 11. Information regarding the physical page within the FMPK 20 is stored in each record within the block management table 1150. The block management table 1150 includes columns of a block #1151, a physical page #1152, a status 1153, an error bit count 1154, a last WR time 1155, an elapsed time after WR 1156, and a life ratio 1157.

The block #1151, the physical page #1152 and the status 1153 are respectively the same information as the block #1104, the physical page #1105 and the status 1103 of the logical-physical conversion table 1100. That is, if a certain physical page is allocated to a logical page, the block # and the physical page # of the allocated physical page is stored in the block #1104 and the physical page #1105 of the logical-physical conversion table 1100, and “allocated” is stored in the status 1103. At the same time, “allocated” is also stored in the status 1153 (in the block management table 1105) of the allocated physical page.

An error bit count that has occurred when an inspection program described later has been executed is stored in the error bit count 1154. The details will be described when describing the inspection program. In the last WR time 1155, the last time when write (or erase) has been performed to the physical page is stored. Further, the elapsed time from when the physical page has been last written (or erased) is stored to the elapsed time after WR 1156 when the inspection program described later is executed. The life ratio calculated when an operation information tabulation program described later is executed is stored in the life ratio 1157. The life ratio will be described in detail below.

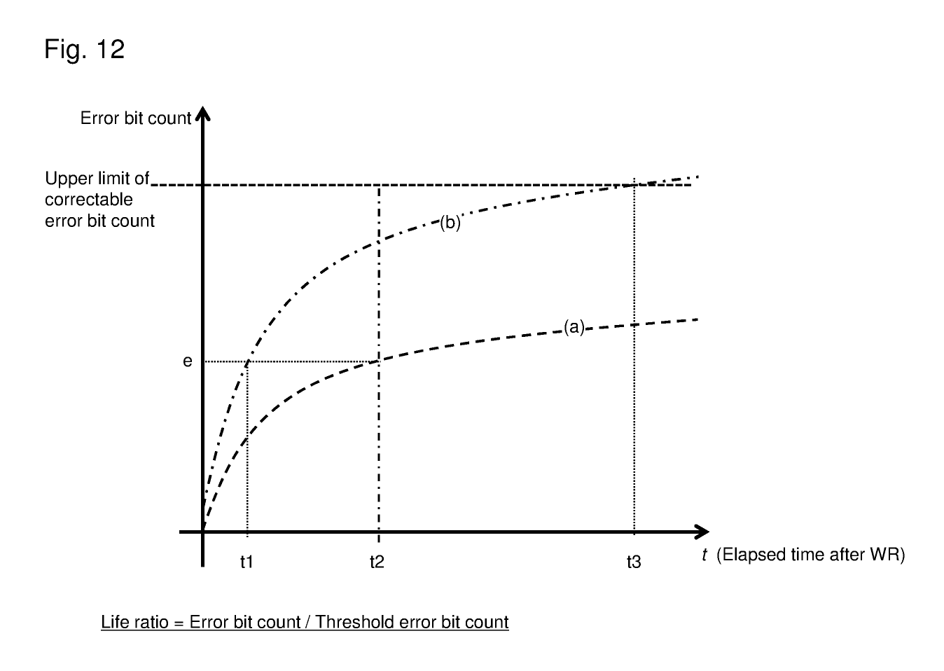

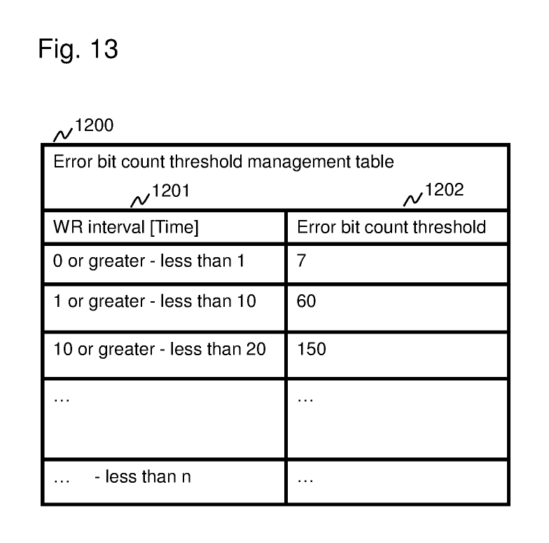

Next, the life ratio and the average life ratio which are indexes used for managing life according to the storage apparatus 1 of the present embodiment will be described with reference to FIGS. 12 and 13. When the FMPK 20 stores data in the physical page, the ECC (Error Correcting Code) is calculated from the data, and the ECC is stored to the physical page together with the data. As a characteristic feature of the flash memory, the error contained in the stored data tends to increase as time elapses after storing the data to the physical page. The meaning of the term “error” will be explained simply. For example, even if the FMPK 20 stores “0” in a certain area (assuming that it is a one-bit area) in the FM chip, it may be possible that the content of the data is changed from “0” to “1” along with the elapse of time. In the present specification, this phenomenon is referred to as “occurrence of an error”. Further, the one-bit area in which error has occurred (or one-bit data having been read from the one-bit area where error has occurred) is referred to as “error bit”. The causes of occurrence of an error are, for example, deterioration of the area due to multiple rewrites, or the inherent bad quality (ability to retain the stored data content) of the area. However, since an ECC is added to the data stored in the physical page, even if an error is contained when data is read, data correction using the ECC is enabled if the number of error bits included in the read target area is equal to or smaller than a given number.

The upper limit of the correctable number of bits depends on the strength (error correction ability) of the added ECC. If there are a number of error bits exceeding the upper limit of the correctable number of bits (hereafter, this is called “upper limit of correctable error bit count”) that can be corrected by ECC contained in the data stored in the physical page, that data becomes unreadable. When error bits equal to or exceeding a predetermined threshold (this threshold is called an “error bit count threshold”; however, the following relationship is satisfied: error bit count threshold<upper limit of correctable error bit count) is included in the data stored in a certain physical page, the FMPK controller 200 stops use of the physical block including that physical page (at this point of time, the data stored in that physical block is moved to a different physical block by the CPU 201 of the FMPK 20). Thereby, it becomes possible to avoid, as much as possible, a case where the data becomes unreadable from the FMPK 20 (a case where an uncorrectable error occurs).

Further, the number of error bits contained in the data stored in a physical page tends to increase along with the elapsed time after write. FIG. 12 shows an example of a graph showing the relationship between the error bit count contained in the data read from the storage area (such as the physical page) of the FM and the elapsed time after write. Curved line (a) of FIG. 12 shows one example of a graph plotting the number of error bits detected by reading a physical page (temporarily called “page a”) when time t has elapsed after writing data to the page a in an FM chip (temporarily called chip A). Similarly, curved line (b) shows one example of a graph plotting the number of error bits detected by reading a physical page (temporarily called “page b”) when time t has elapsed after writing data to page b in an FM chip (temporarily called chip B). The horizontal axis of the graph shows the elapsed time after write to the physical page, and the vertical axis shows the number of error bits (hereinafter referred to as “number of detected error bits”) detected when the physical page has been read.

As shown in FIG. 12, regarding both pages a and b, the error bit count detected during read tends to be increased as the elapsed time after write becomes longer. However, in the case of page b, e number of error bits are detected when the elapsed time after write is t1, whereas in the case of page a, e number of error bits are detected when the elapsed time after write is t2 (t1<t2). In that case, the speed of increase of error bit count is faster in page b than page a, so that the possibility of the number of detected error bits of page b exceeding the upper limit of correctable error bit count earlier than page a is high. In the case of FIG. 12, at the point of time when the elapsed time after write reaches t3, the number of detected error bits of page b exceeds the upper limit of correctable error bit count. Therefore, it is preferable to stop use of the relevant physical page of page b at an early timing. However, regarding page a, as can be seen from the graph of FIG. 12, the possibility of the number of detected error bits exceeding the upper limit of correctable error bit count is small, even if the elapsed time after write becomes quite long. Therefore, it is possible to continue use of page a.

At this time, when assuming that the error bit count threshold is set to e, the uses of both pages a and b are stopped. In other words, the use of page a is stopped even when page a is in a usable state. The use of a single value as the error bit count threshold is not preferable, since the use of the page in a usable state will also be stopped. Therefore, according to the FMPK 20 of the present embodiment, the error bit count threshold is defined for each elapsed time after write. When determining whether it is necessary to stop using the page when (a physical block including) a physical page is inspected, the FMPK 20 derives an appropriate error bit count threshold based on the elapsed time after write of the relevant page, and calculates “the number of detected error bits÷derived error bit count threshold”. This value is called “life ratio”. As a result of having calculated the life ratio of the physical page, if the life ratio is equal to or greater than 1, the FMPK 20 determines that the use of the relevant physical page should be stopped. In other words, life ratio is an index value showing the level of degradation of the FM chip (or the physical page), and the greater life ratio of a physical page indicates greater deterioration of the physical page (that the end of life is close).

FIG. 13 shows the contents of an error bit count threshold management table 1200. The error bit count threshold management table 1200 includes columns of a WR interval 1201 and an error bit count threshold 1202. The WR interval 1201 is a column storing information of the range of elapsed time after write of the physical page. It shows that the error bit count threshold of the physical page whose elapsed time after write is within the range stored in the WR interval 1201 is a value stored in the error bit count threshold 1202. When computing the life ratio of the physical page, the FMPK 20 searches for the row whose range of the value of the WR interval 1201 includes the elapsed time after write of the inspection target physical page from the respective rows of the error bit count threshold management table 1200. Thereafter, the value stored in the error bit count threshold 1202 of the searched row is used as the error bit count threshold.

In the present embodiment, a method for determining the error bit count threshold using the error bit count threshold management table 1200 is described, but the error bit count threshold can also be determined by other methods. For example, it is possible to provide to the storage controller 10 a function to output the error bit count threshold when the elapsed time after write is input, instead of using the table such as the error bit count threshold management table 1200.

The above has described the major management information stored in the memory 14 of the storage controller 10 and the memory 204 of the FMPK controller 200. In the following description, the details of the processes executed by the storage controller 10 and the FMPK controller 200 will be described.

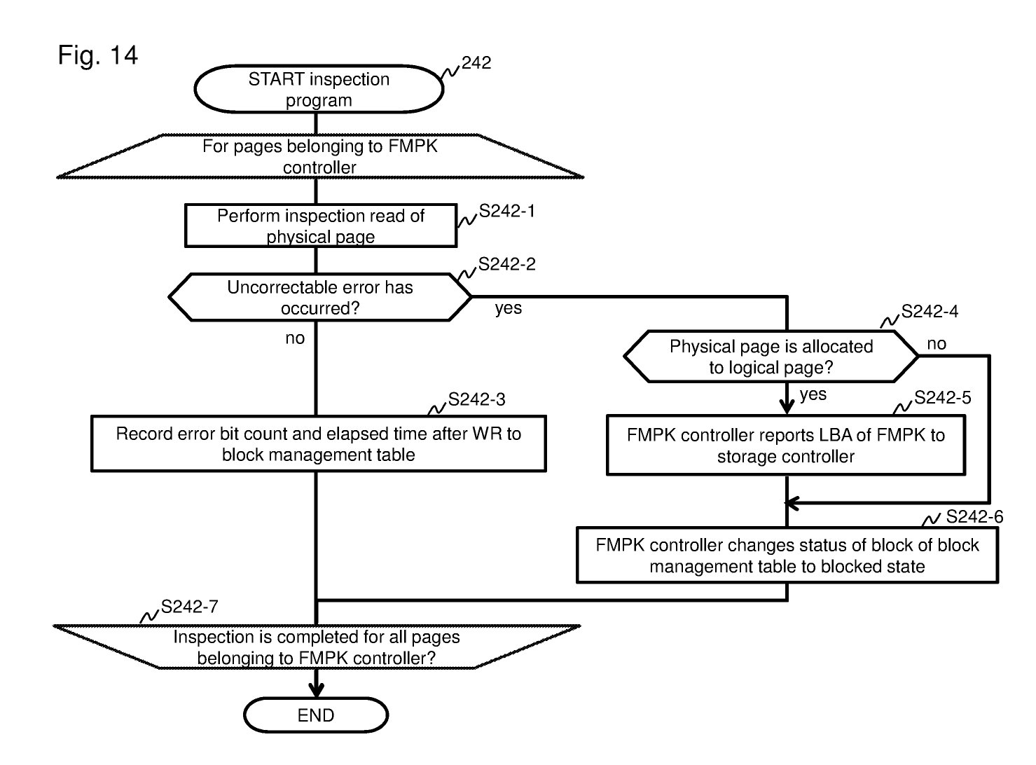

FIG. 14 shows a processing flow of the inspection program 242. The inspection program 242 is executed periodically by the CPU 201 of the FMPK 20. Hereafter, the processes executed by the inspection program 242 are referred to as “inspection processing”. When the execution of the inspection program 242 is started, read (inspection read) is performed to all physical pages within the FMPK 20.

In S242-1, the CPU 201 selects one uninspected physical page, and performs data read of the selected physical page. During the read processing, the FM chip I/F 203 performs a data error check using the ECC added to the data. When it is determined that data error exists, the FM chip I/F 203 attempts data correction using the ECC. As a result of the attempt to perform data correction, there are cases where data correction succeeds and where data correction fails. When data correction fails, a notice stating that an “uncorrectable error” has occurred is notified from the FM chip I/F 203 to the CPU 201. On the other hand, when data correction succeeds, a notice stating that a “correctable error” has occurred is notified from the FM chip I/F 203 to the CPU 201. Further, when a correctable error occurs, in addition to the notice stating that “correctable error” has occurred, the number of error bits contained in the data is notified from the FM chip I/F 203 to the CPU 201.

When an uncorrectable error is reported to the CPU 201 (S242-2: Yes), the CPU 201 judges whether the read target physical page is allocated to a logical page or not by referring to the status 1153 of the block management table 1150 (S242-4). If the read target physical page is allocated to a logical page (S242-4: Yes), the CPU 201 calculates the LBA of the FMPK from the logical page number of the logical page to which the read target physical page is allocated. Then, the calculated LBA is reported to the storage controller 10 (S242-5). Further, the CPU 201 sets the status of the physical block including the read target physical page to blocked state. Specifically, “blocked” is stored in the status 1153 for all physical pages within the physical block including the read target physical page.

If an uncorrectable error is not reported to the CPU 201 (S242-2: No), the CPU 201 adds the error bit count notified from the FM chip I/F 203 to the error bit count 1154 of the block management table 1150 (S242-3). Further, the value of (current time−last WR time 1155) is calculated (this calculated value is the elapsed time after write), and the calculated value is stored in the elapsed time after WR 1156.

However, S242-3 is a process performed when a correctable error is reported. If a correctable error is not reported (that is, if an error has not occurred), S242-3 will not be performed.

After S242-3 or S242-6, the CPU 201 judges whether the processes of S242-1 through S242-6 have been performed for all physical pages (S242-7). If the processes have been completed for all physical pages, the CPU 201 ends the inspection processing. If there is still a physical page where the processes are not completed, the CPU 201 repeats the processes from S242-1.

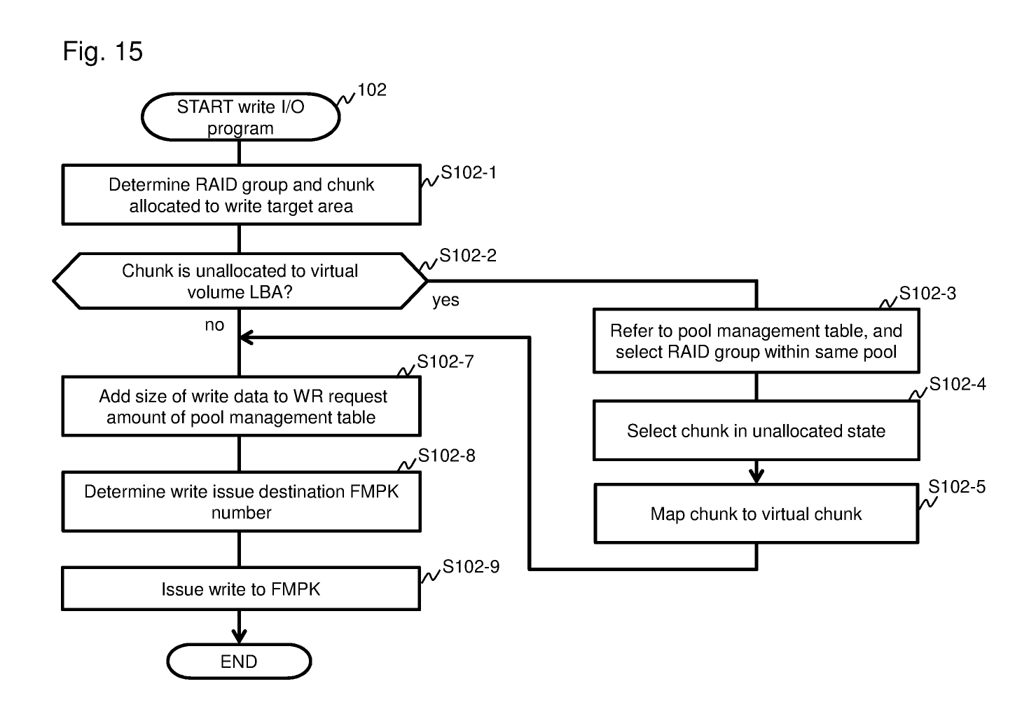

Next, the flow of the processes performed by the storage write I/O program 102 (hereafter, this process is called “write processing”) will be described with reference to FIG. 15. The storage write I/O program 102 is executed by the CPU 201 when a write request is received from the host 2. The write request (write command) that the storage controller 10 receives from the host 2 includes, as information for specifying the write destination of the write target data, virtual volume number (or other information capable of deriving the virtual volume number in the storage controller 10, such as the LUN (Logical Unit Number)), the LBA in the virtual volume, and the length of the write target data (called a write data length). Hereafter, in the description of FIG. 15, the area specified by the virtual volume number, the LBA in the virtual volume and the write data length is called a “write target area”. Further, the virtual volume where the write target area exists is called a write target virtual volume.

When the write command arrives at the storage controller 10, the CPU 11 derives the virtual chunk number of the virtual chunk including the write target area and the information for specifying the chunk mapped to the virtual chunk (RAID group number and chunk number) based on the virtual volume number, the LBA and the write data length included in the write command (S102-1). Specifically, the CPU 11 refers to the virtual volume management table 500, and searches for the row where the virtual volume #501 and the virtual volume LBA range 503 includes the write target area designated in the write command. The virtual chunk number 504 of the searched row is the virtual chunk number of the virtual chunk including the write target area. Further, the RAID group number 505 and the chunk number 506 of the relevant row is the RAID group number and the chunk number of the chunk mapped to the write target area. Here, we will describe the case where the write target area is an area of a range that fits in a single chunk.

However, there may be a case where a chunk is not allocated to the write target area, and in that case, the RAID group number 505 and the chunk number 506 searched in S102-1 are NULL. When the RAID group number 505 and the chunk number 506 are NULL, that is, if a chunk is not allocated to the write target area (S102-2: Yes), the CPU 11 specifies the pool #502 to which the chunk capable of being allocated to the write target virtual volume is specified by referring to the virtual volume management table 500. Thereafter, by referring to the pool management table 550, the CPU 11 select a RAID group belonging to the specified pool #, and select one chunk whose status 555 is “unallocated” out of the chunks within the selected RAID group (S102-3, S102-4).

When a chunk is selected, the CPU 11 stores the RAID group number (RG #552) to which the selected chunk belongs and the chunk #553 to the RAID group number 505 and the chunk number 506 of the virtual volume management table 500, respectively (S102-5). Thereby, the chunk is mapped to the virtual chunk including the write target area.

After S102-5 (or after the judgement of S102-2 if a chunk is already allocated to the virtual chunk including the write target area), S102-7 is performed. In S102-7, the CPU 11 receives the write data from the host 2, and stores the same in the cache. Thereafter, it generates the parity to be stored in the parity stripe. The generation of the parity is performed using a well-known RAID technique. Then, it adds the write data length and the length of the generated parity corresponding to the write data to the WR request amount 556 (managed by the pool management table 550) of the chunk mapped to the write target area (chunk specified by S102-1, or chunk mapped in S102-5).

Next, the CPU 11 specifies the FMPK # of the FMPK 20 and the LBA in the FMPK 20 being the write destination of the write target data (S102-8). Then, the CPU 11 issues a write request to the specified LBA of the FMPK 20 to store data (S102-9). Thereafter, the CPU 11 responds to the host 2 that the write processing has been ended, and ends the processing.

In S102-8, the FMPK # of the FMPK 20 and the LBA in the FMPK 20 being the write destination of the parity generated in S102-7 are also specified, in addition to that of the write target data (data received from the host 2). Similarly in S102-9, the parity is also stored in the FMPK 20 in addition to the write target data. How to specify the FMPK # of the FMPK 20 and the LBA in the FMPK 20 being the write destination of the write target data (and parity) performed in S102-8 is a well-known process in a storage device adopting a RAID technique, so that detailed description thereof is omitted.

The above description has described an example where the storage write I/O program 102 having received the write request from the host executes data write to the FMPK 20, and thereafter, responds to the host that the write processing has been completed. However, in another example, the storage write I/O program 102 having received the write request from the host can respond end of processing to the host 2 at the point of time when the write target data is stored in the cache, and thereafter, perform a process to collectively store a plurality of write target data to the FMPK 20 asynchronously.

The FMPK 20 having received the write request and the write data from the storage controller 10 stores the data in the FM chip 210. This process is similar to the process performed in a well-known SSD and the like, so that the detailed description thereof is omitted. Also, the FMPK 20 stores the total amount of write data transmitted from the storage controller 10 in the memory 204 (or the FM chip 210 and the like). Therefore, the FMPK 20 performs a process to accumulate the write data lengths included in the write requests, each time it receives a write request from the storage controller 10.

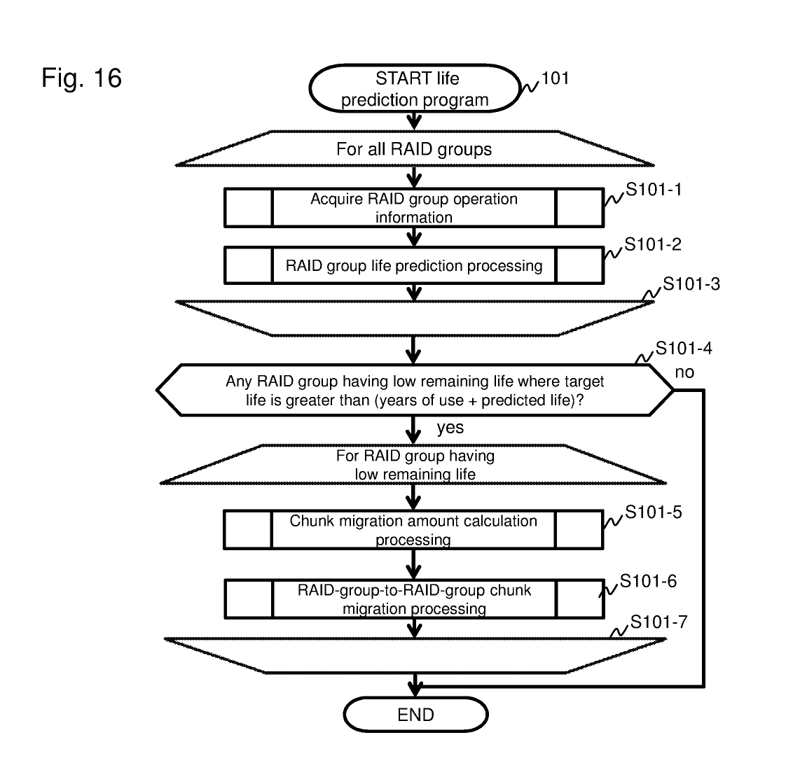

Next, the processing flow of the life prediction program will be described with reference to FIG. 16 and thereafter. FIG. 16 illustrates the overall flow of the process performed by the life prediction program. Hereafter, the processes executed by the life prediction program are called “life prediction processing”. The life prediction program is executed periodically by the CPU 11.

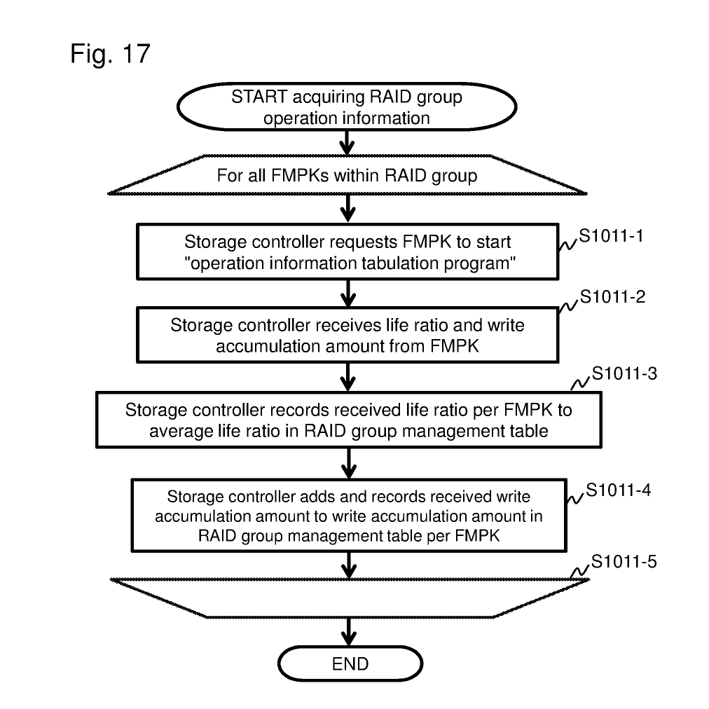

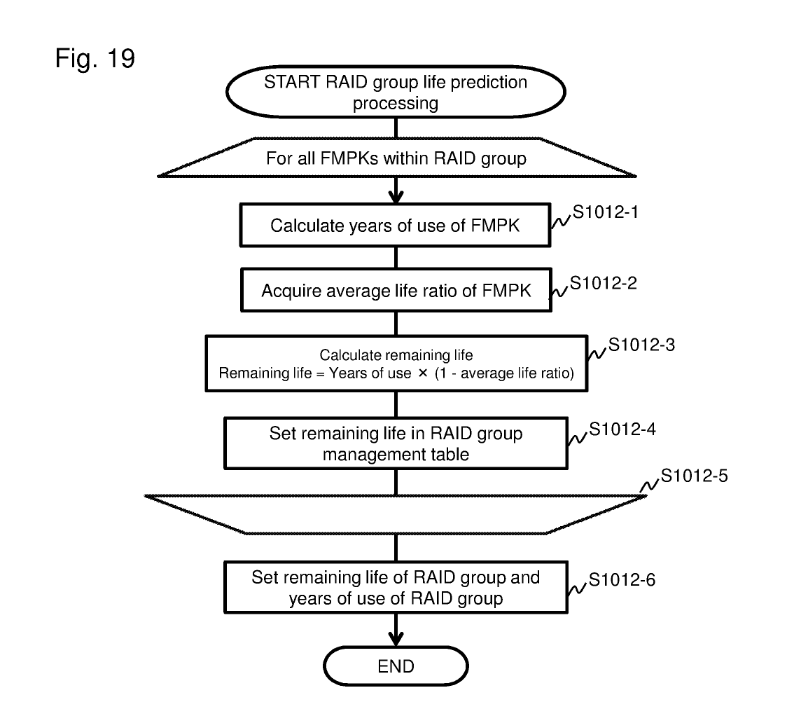

When the execution of the life prediction program is started, the CPU 11 executes a RAID group operation information acquisition processing (S101-1) and a RAID group life prediction processing (S101-2) to all RAID groups within the storage apparatus 1. The flow of the RAID group operation information acquisition processing will be described later with reference to FIG. 17. Further, the flow of the RAID group life prediction processing will be described later with reference to FIG. 19.

After the life prediction processing is executed to all RAID groups, the CPU 11 judges whether there is a RAID group whose remaining life is shorter than the target service life (target life) (S101-4). This judgement is done by referring to the information stored in the RAID group management table 650 for each RAID group. Specifically, the CPU 11 judges whether there is a RAID group whose years of use of RAID group 660, remaining life of RAID group 659 and target life 656 satisfy the following relationship:

(years of use of RAID group 660+remaining life of RAID group 659)<target life 656.

The RAID group satisfying this relationship is determined to have a remaining life shorter than the target service life. Generally, the FMPKs 20 belonging to one RAID group use the same type of FMPKs, so that the target life 656 of each FMPK 20 belonging to the RAID group is the same. Therefore, the target life 656 of the FMPK 20 can be recognized as the target life of the RAID group to which that FMPK 20 belongs.

If a RAID group having a remaining life shorter than the target service life exists (S101-4: Yes), the CPU 11 executes a chunk migration amount calculation processing (S101-5) and a RAID-group-to-RAID-group chunk migration processing (S101-6) to these RAID groups. After executing these processes, the life prediction processing is completed. If there are a plurality of RAID groups whose remaining life is shorter than the target service life, the CPU 11 executes the processes of S101-5 and S101-6 to all RAID groups whose remaining life is shorter than the target service life.

Next, the flow of the RAID group operation information acquisition processing will be described with reference to FIG. 17.

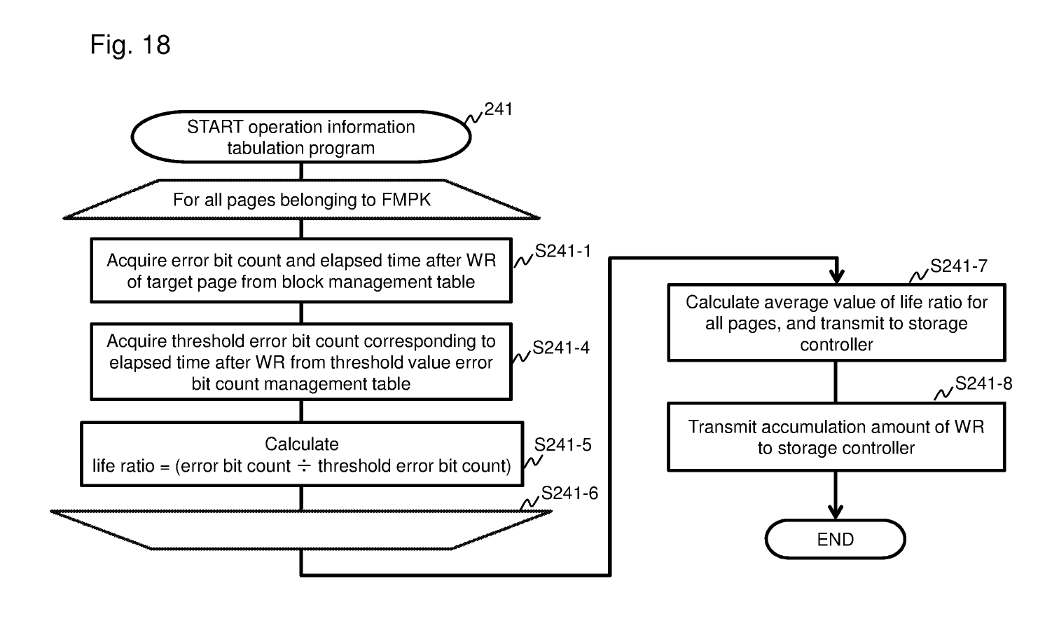

When the RAID group operation information acquisition processing is started, the CPU 11 issues an operation information tabulation command to all FMPKs 20 within the RAID group (S1011-1). The FMPK 20 having received the operation information tabulation command calculates the life ratio and the write accumulation amount of the FMPK 20, and transmits the same to the CPU 11. The details of the processing executed by the FMPK 20 having received the operation information tabulation command will be described later with reference to FIG. 18.

In S1011-2, the CPU 11 receives the life ratio and the write accumulation amount from the FMPK 20. Then, the CPU 11 stores the received life ratio and write accumulation amount to the average life ratio 654 and the write accumulation amount 655 of the RAID group management table 650 (S1011-3, S1011-4). When the processes of S1011-1 through S1011-4 have been completed for all FMPKs 20 within the RAID group, the RAID group operation information acquisition processing is ended. Instead of receiving the write accumulation amount from the FMPK 20, it is possible to manage the accumulation amount of write data issued to each FMPK 20 by the storage controller 10, and have that value stored in the write accumulation amount 655.

Now, the flow of the processing performed when the FMPK 20 has received an operation information tabulation command will be described with reference to FIG. 18. When the FMPK 20 receives an operation information tabulation command, the FMPK 20 starts executing the operation information tabulation program 241. The operation information tabulation program 241 is executed by the CPU 201.

When the operation information tabulation program 241 is started, the CPU 201 performs calculation of the life ratio for the pages within the FMPK 20. At first, a page whose life ratio is not yet calculated is selected. Here, we will assume that the physical block number of the selected page is b, and the page number thereof is p. The selected page is called a “processing target page”. Then the error bit count and the elapsed time after WR of the processing target page are acquired (S241-1). The error bit count and the elapsed time after WR acquired here are the error bit count 1154 and the elapsed time after WR 1156 respectively stored in the row where the block #1151 is b and the physical page #1152 is p within the block management table 1150. In other words, the error bit count and the elapsed time after WR, which are stored in the block management table 1150 when the inspection program 242 is executed, are acquired.

Next, the CPU 201 refers to the threshold error bit count management table 1200, and searches for the row where the WR interval 1201 contains the elapsed time after WR acquired in S241-1. Then, the threshold error bit count 1202 of the searched row is acquired (S241-4). Thereafter, the CPU 201 divides the error bit count acquired in S241-1 by the threshold error bit count acquired in S241-4. The value calculated by this dividing operation is the life ratio of the processing target page. The CPU 201 stores this calculated life ratio in the life ratio 1156 of the row where the block number #1151 is b and the physical page #1152 is p within the block management table 1150 (S241-5).

When the processes of S241-1 through S241-5 have been completed for all pages within the FMPK 20, the CPU 201 performs the processes of S241-7 and thereafter. In S241-7, the CPU 201 calculates the average value of the life ratio 1156 of all pages stored in the block management table 1150, and transmits the same to the storage controller 10. Further, the CPU 201 transmits the write accumulation amount stored in the memory 204 to the storage controller 10 (S241-8), and ends the processing. If the write accumulation amount is managed by the storage controller 10, the FMPK 20 is not required to transmit the write accumulation amount to the storage controller.

Next, the flow of the RAID group life prediction processing will be described with reference to FIG. 19. In the RAID group life prediction processing, the processes of S1012-1 through S1012-4 are performed for all FMPKs belonging to the RAID group. Hereafter, we will describe an example of a case where the processes of S1012-1 through S1012-4 are performed for the FMPK 20 whose drive number is n.

In S1012-1, the CPU 11 refers to the row where the drive number 652 is n in the RAID group management table 650, and acquires the use start date 658 of FMPK #n. Then, by calculating the (current date and time−use start date 658)÷365, the years of use of FMPK #n is calculated. Next, the CPU 11 refers to the row where the drive number 652 is n in the RAID group management table 650, and acquires the average life ratio 654 of FMPK #n (S1012-2). Further, the CPU 11 uses the years of use calculated in S1012-1 and the average life ratio 654 acquired in S1012-2 to compute the remaining life of the FMPK #n. The calculation of the remaining life is performed based on the following calculation formula.

Remaining life of FMPK #n=(years of use calculated in S1012-1)×(1−average life ratio 654)

In S1012-4, the CPU 11 stores the remaining life calculated in S1012-3 in the remaining life 657 (remaining life 657 of the row where the drive number 652 is n in the RAID group management table 650).

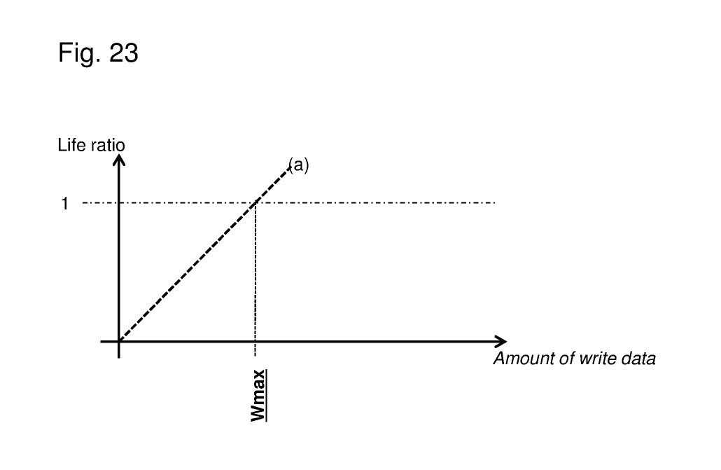

Now, the concept of calculation of the remaining life described above will be described with reference to FIG. 23. The error bit count detected during reading of the physical page tends to increase along with the increase of the amount of write data to the relevant physical page. According to the storage apparatus 1 of the present embodiment, life is predicted based on the assumption that the life ratio of the physical block (error bit count÷error bit count threshold) and the write accumulation amount is in a proportional relationship. The write accumulation amount that has occurred to a certain physical block until the life ratio of a certain physical block reaches 1 (thereafter, the use of this physical block is stopped) is referred to as “Wmax”.

Further, regarding the calculation of the remaining life described above, the remaining life is calculated assuming that the write rate (amount of write per unit time) to each FMPK 20 is fixed. In other words, the remaining life is calculated assuming that the average life ratio 654 and the WR accumulation amount 655 of the FMPK 20 are also in a proportional relationship. Therefore, in the storage apparatus 1 of the present embodiment, the remaining life of FMPK #n is calculated based on the above-described calculation formula.

Actually, the life characteristics of the flash memories are uneven among FM chips. Therefore, in each FM chip, though the life ratio and the write accumulation amount are in a proportional relationship, the value of Wmax may differ among FM chips.

Therefore, if the amount of write is not controlled for each FM chip, an inaccessible FM chip may arise before the target service life arrives. If so, the FMPK 20 itself equipped with the FM chip may become unusable (the FMPK 20 becomes unusable before reaching the target service life). Therefore, the FMPK 20 according to the present embodiment observes the life ratio in each physical page within the FMPK 20, and it selects the appropriate physical blocks for the data migration source and the data migration destination when performing reclamation or wear leveling. That is, when a physical block having a high life ratio (close to 1) exists, the FMPK 20 migrates data from that physical block to a physical block having a small life ratio, to thereby perform control so that the life ratio of the respective physical blocks become uniform. Thereby, the FMPK prevents a specific FM chip from becoming unusable at an early stage. Therefore, in the storage controller 10, by adjusting the amount of write data among FMPKs 20 so that the average value of the life ratio (average life ratio 654) of each FMPK 20 becomes uniform, the life of each FMPK 20 and the life of each FM chip within the FMPK 20 can be made substantially uniform, and as a result, each FMPK 20 can be used to its target service life.

The reclamation and wear leveling performed in the FMPK 20 is substantially the same as those performed in a well-known flash storage. In a well-known flash storage, when performing reclamation and wear leveling, the data migration source and data migration destination physical blocks are selected based on the amount of write data to a block (or the number of erases in a block). On the other hand, when performing reclamation and wear leveling in the FMPK 20 according to the present embodiment, the data migration source and data migration destination physical blocks are selected based on the life ratio, which differs from the well-known flash storage. However, they are not the same in other aspects. Therefore, the detailed description of the reclamation and wear leveling performed in the FMPK 20 will be omitted.

After the processes of S1012-1 through S1012-4 have been performed for all FMPKs belonging to the RAID group, the CPU 11 selects the smallest value of the remaining life 657 of each FMPK 20 belonging to the processing target RAID group stored in the RAID group management table 650, and stores the same in the remaining life of RAID group 659 (S1012-6). One example will be described with reference to FIG. 8. In FIG. 8, as a result of executing the processes of S1012-1 through S1012-4, the remaining life of each drive (FMPK #0, #1, #2 and #3) constituting the RAID group whose RG #651 is 1 is in a state as stored in the column of the remaining life 657 of the RAID group management table 650. According to FIG. 8, the remaining life of each drive (FMPK #0, #1, #2 and #3) is, in the named order, four years, three years, three-and-a-half years, and four years, respectively. Therefore, in S1012-6, the CPU 11 determines that the remaining life of the RAID group #1 is three years (since the smallest value among four years, three years, three-and-a-half years, and four years is three years), and stores “three years” in the remaining life of RAID group 659 of RAID group #1.

Also in S1012-6, the CPU 11 calculates:

(current date(year,month,date)−use start date 658 of the FMPK 20 having the smallest remaining life 657)÷365,

and stores the value in the years of use of RAID group 660. In other words, the storage apparatus 1 according to the present embodiment uses the years of use of the FMPK 20 having the smallest remaining life 657 as the years of use of the RAID group.

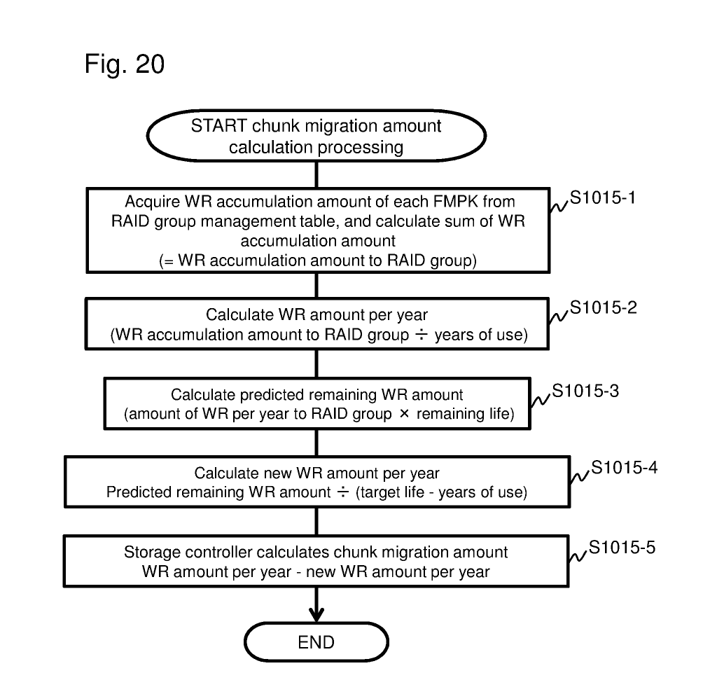

The (predicted) life of each RAID group is calculated by the processes of FIGS. 16 and 19. As described with reference to FIG. 16, if a RAID group having a calculated (predicted) life shorter than the target remaining life exists, the CPU 11 executes a chunk migration amount calculation processing and RAID-group-to-RAID-group chunk migration processing, and migrates the data of the RAID group whose remaining life is shorter than the target remaining life to a different RAID group. The object of this process is to enable the respective FMPKs 20 to be used to the target service life. The details of these processes will be described with reference to FIGS. 20 through 22.

FIG. 20 is a flowchart of the process of S101-5 illustrated in FIG. 16, that is, the chunk migration amount calculation processing. Here, the amount of data (number of chunks) migrated from the RAID group having a remaining life that is shorter than the target remaining life to a different RAID group is calculated.

In S1015-1, the CPU 11 calculates a write accumulation amount regarding a RAID group. Actually, the CPU 11 acquires the write accumulation amount 655 of all FMPKs 20 belonging to the RAID group from the RAID group management table 650, and computes the total sum thereof (S1015-1). Next, the CPU 11 converts the write accumulation amount of the RAID group to the amount of WR per unit time. Specifically, the CPU 11 divides the write accumulation amount regarding the RAID group calculated in S1015-1 by the years of use of RAID group 660, and calculates the amount of WR per year (S1015-2).

Next, in S1015-3, the CPU 11 calculates the amount of write that the process target RAID group is capable of receiving from the current time (point of time of execution of S1015-3) before reaching its life (this value is called a “predicted remaining amount of WR”). In the storage apparatus 1 of the present embodiment, the predicted remaining amount of WR is calculated on the assumption that the amount of WR that will occur to the RAID group occurs with the same frequency as the amount of WR per unit time (per year) calculated in S1015-2. In other words, the predicted remaining amount of WR can be calculated by computing:

amount of WR for RAID group per unit time×remaining life of RAID group 659

Next, in S1015-4, the CPU 11 calculates the amount of WR per unit time after executing the chunk migration processing. Hereafter, the amount of WR per unit time after data migration is called “new amount of WR per year”. The new amount of WR per year can be obtained by calculating the predicted remaining amount of WR÷(target life−years of use of RAID group).

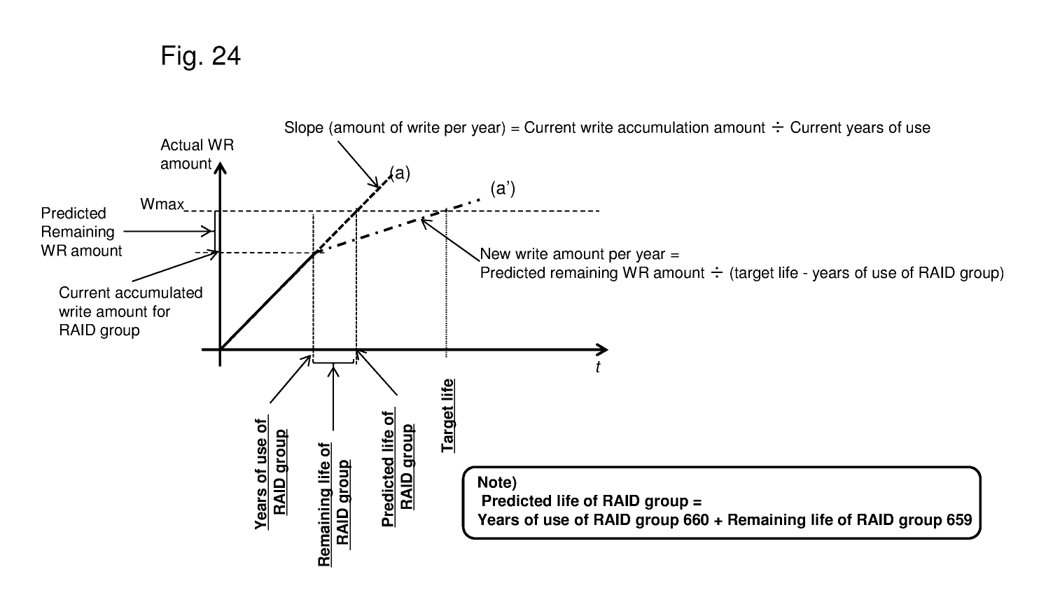

We will now describe the outline of the method for calculating the new amount of WR per year. FIG. 24 is a graph showing the relationship between the operating time of the RAID group and the amount of write thereof. Straight line (a) is a graph showing the case where write occurs to the RAID group by the same write rate as before. The slope of straight line (a) indicates:

write accumulation amount of RAID group÷years of use of RAID group 660,

so that it is equal to the amount of WR per year calculated in S1015-2.

Further, the predicted remaining amount of WR and Wmax computed in S1015-3 satisfies the following relationship, as shown in FIG. 24:

predicted remaining amount of WR=Wmax−write accumulation amount regarding RAID group

Conversely, the processing target RAID group is capable of writing the amount of write data equal to or smaller than the predicted remaining amount of WR calculated in S1015-3. The aim of the process performed here is to enable each FMPK 20 constituting the RAID group to be used to their target life (target service life). If the amount of WR per unit time (years) with respect to the processing target RAID group is set to be equal to or smaller than the slope of straight line (a′) of FIG. 24, that is:

predicted remaining amount of WR÷(target life−years of use of RAID group),

it can be said that the data write to the processing target RAID group is possible (the life ratio will not exceed 1, that is, the FMPK 20 constituting the RAID group will not be unavailable) until the target life arrives. Therefore, according to the storage apparatus 1 of the present embodiment, the value calculated by this formula is determined to be the “new amount of WR per year”.

Thereafter, in S1015-5, the CPU 11 calculates the amount of data to be migrated from the processing target RAID group to a different RAID group, and ends the process. In order to calculate the amount of data to be migrated, in S1015-5, the CPU 11 calculates the following:

(amount of WR per year calculated in S1015-2−new amount of WR per year calculated in S1015-4).

In the following description, this calculated value is called a “chunk migration amount”.

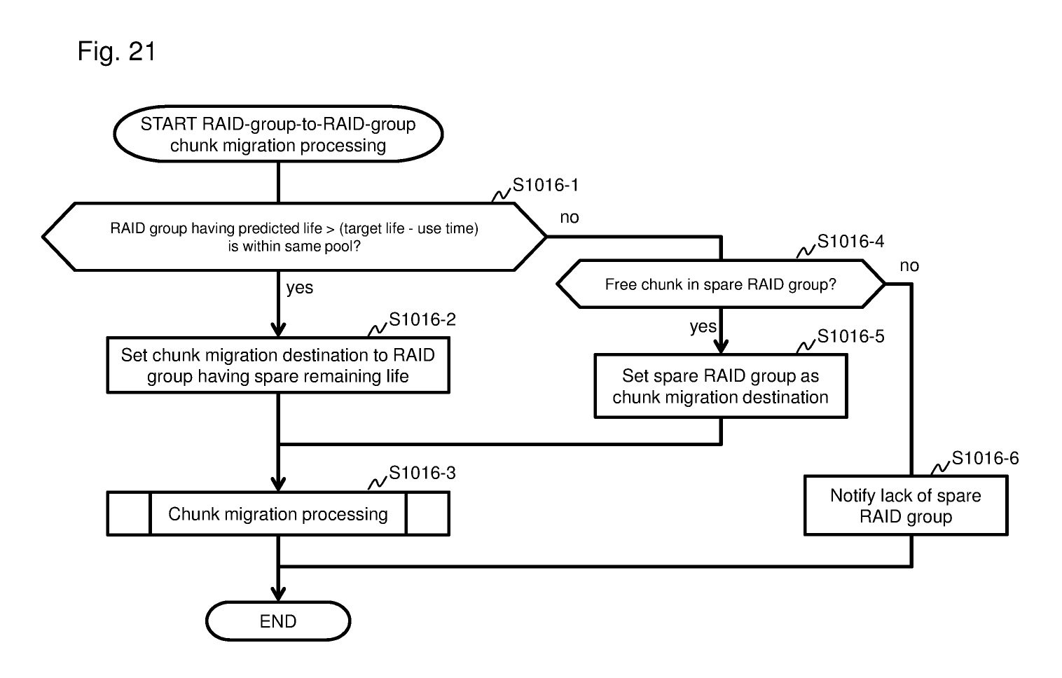

Next, the flow of the RAID-group-to-RAID-group chunk migration processing will be described with reference to FIG. 21. In the present process, the data migration destination RAID group is determined, and the data is migrated. In principle, the RAID group belonging to the same pool as the data migration source RAID group (RAID group selected in S101-4 having a shorter remaining life than initially scheduled) should be selected as the data migration destination.

At first, the CPU 11 refers to the RAID group management table 650, and searches for a RAID group whose remaining life of RAID group 659 is greater than (target life 656−years of use of RAID group 660). Then, by referring to the pool management table 550, it judges whether there is a RAID group within the searched RAID groups that belongs to the same pool as the migration source RAID group, and having an unused area (chunk whose status 555 is “unallocated”) (S1016-1). If a RAID group matching this condition exists (S1016-1: Yes), the RAID group matching this condition is determined as the data migration destination (S1016-2). In the judgement of S1016-1, if there is a plurality of RAID groups matching this condition, an arbitrary RAID group can be selected. It is also possible to perform determination such as selecting the RAID group having the greatest amount of unused areas (having the greatest amount of chunks whose statuses 555 are “unallocated”), selecting the RAID group whose sum of the WR request amount 556 is the smallest, selecting the RAID group whose years of use of RAID group 660 managed by the RAID group management table 650 is the shortest, or the RAID group whose remaining life of RAID group 659 is the greatest. As another example, if there are pluralities of migration target chunks in the migration source RAID group, it is possible to have multiple RAID groups set as the migration source, and have the respective chunks migrated to multiple RAID groups.

In the judgement of S1016-1, if there is no RAID group matching the conditions (S1016-1: No), the CPU 11 judges whether there is a free area in the spare RAID group (S1016-4). If a free area exists in the spare RAID group (S1016-4: Yes), the data migration destination is determined to be the spare RAID group (S1016-5).

After S1016-2 or S1016-5, the CPU 11 performs data migration from the migration source RAID group to the migration destination RAID group (RAID group determined in S1016-2 or S1016-5) (S1016-3), and ends the RAID-group-to-RAID-group chunk migration processing. The processing performed in S1016-3 is called “chunk migration processing”. The details of the chunk migration processing will be described later.

As a result of the judgement of S1016-4, if a free space does not exist in the spare RAID group (S1016-4: No), the CPU 11 sends a message via the management host I/F to the management host 5 notifying that there is not enough spare RAID group, and ends the process. The management host 5 having received this notification performs a process, such as displaying a message that there is not enough spare RAID group on the screen of the management host 5.

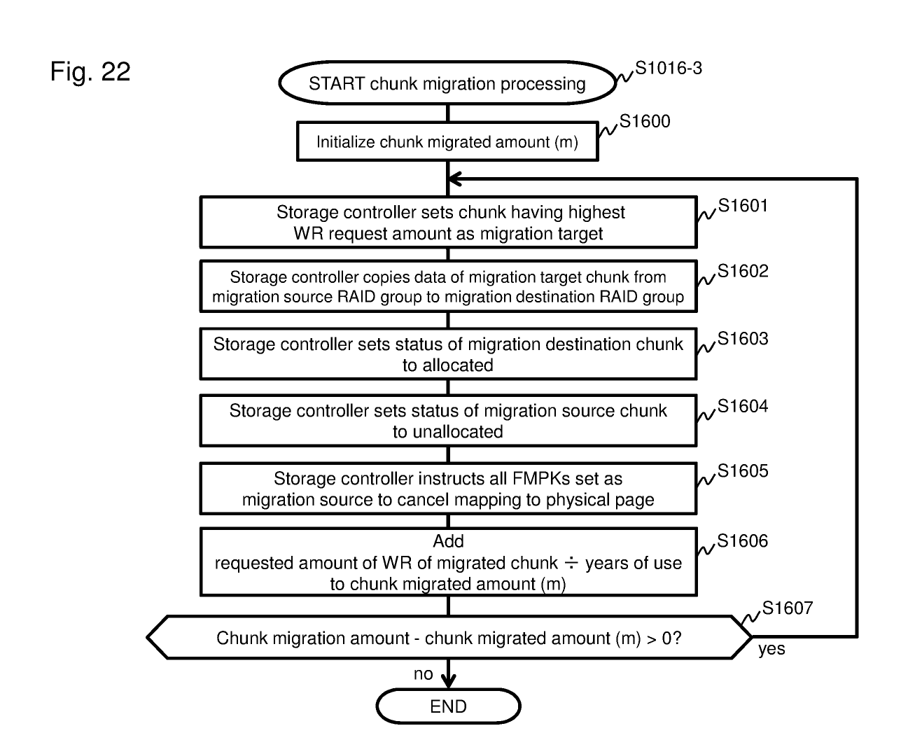

Next, the details of the chunk migration processing performed in S1016-3 will be described with reference to FIG. 22. At first, the CPU 11 prepares a variable m, and initializes the value of m (substitutes 0) (S1600). The variable m is used to store the integrated value of the amount of migrated data when data migration is performed in S1602 that will be described later. This variable m is also referred to as “amount of migrated chunk”.

In S1601, the CPU 11 refers to a pool management table 551, and selects a chunk having the greatest value as the WR request amount 556 out of the chunks within the migration source RAID group. The chunk selected here is referred to as a “migration source chunk”. The data stored in the migration source chunk will be the migration target data. In S1601, it is not always necessary to select the chunk having the greatest value of the WR request amount 556. However, the amount of chunks to be migrated can be made small if the chunk having a large value as the WR request amount 556 is set as the migration target. Therefore, according to the chunk migration processing of the present embodiment, the chunks having greater values as the WR request amount 556 are selected sequentially in order as the migration target.

In S1602, the CPU 11 refers to the pool management table 551, and selects one unused chunk (chunk whose status 555 is “unallocated”) from the migration destination RAID group. This selected chunk is called “migration destination chunk”. The CPU 11 copies the migration target data determined in S1601 to the migration destination chunk.

In S1603, the CPU 11 changes the status 555 of the migration destination chunk to “allocated”. Further, in S1604, the CPU 11 changes the status 555 of the migration source chunk to “unallocated”, and sets the WR request amount 556 of the migration source chunk to 0.

When the data stored in the migration source chunk is copied to the migration destination, there will be no more need to store data to the migration source chunk. Therefore, in S1605, the CPU 11 orders the FMPK 20 to cancel the mapping to the logical page of the physical page having been mapped to the migration source chunk. Specifically, the CPU 11 refers to the pool management table 550 to specify the RAID group LBA 554 from the chunk #553 and the RG #552 of the migration source chunk. Using the information of the specified RAID group LBA 554, it specifies the FMPK 20 and the LBA within the storage space of the FMPK 20 in which the migration source chunk exists. The chunk is an area including one or more stripe lines, so that there is a plurality of FMPKs 20 in which the migration source chunk exists. Then, the CPU 11 issues a mapping cancellation command to the (plurality of) FMPKs 20 in which the migration source chunk exists. FMPK LBA 704 is designated as the parameter of the mapping cancellation command issued here, as information for specifying the area being the target of cancellation of mapping. However, instead of the LBA, it is possible to designate the logical page number of the FMPK 20 as the parameter of the mapping cancellation command.

The FMPK 20 having received the mapping cancellation command cancels the mapping of the LBA designated in the parameter of the mapping cancellation command. Specifically, the status 1103 of the row where the FMPK LBA 1101 of the logical-physical conversion table 1100 is the same as the LBA designated in the parameter of the mapping cancellation command is changed to “unallocated”. Further, a row is searched from the block management table 1150 whose values stored in the block #1151 and the physical page #1152 of the block management table 1150 are the same as the values stored in the block #1104 and the physical page #1105 of the formerly-described row, and the status 1153 of the latter row is also changed to “unallocated”. Lastly, the values of the block #1104 and the physical page #1105 of the row where the status 1103 has been changed to “unallocated” in the logical-physical conversion table 1100 are changed to invalid values (NULL).

Next, the CPU 11 adds to the amount of migrated chunk (m) a value having converted the amount of requested WR (value stored in WR request amount 556) of the chunk migrated in S1602 to the amount of write per unit time (year) (S1606).

Specifically, the following is calculated, and the calculated value is added to m:

WR request amount 556÷years of use of RAID group 660

In S1607, the CPU 11 judges whether the amount of migrated chunk has become equal to or greater than the chunk migration amount (value calculated by the process of FIG. 20) or not. If the amount of migrated chunk has become equal to or greater than the chunk migration amount, the process is ended, and if not, the CPU 11 repeats the process again from S1601.

The object of the chunk migration processing is not to receive write data exceeding the predicted remaining amount of WR (or new amount of WR per year×(target life−years of use of RAID group)) calculated in the chunk migration amount calculation processing of FIG. 20 to the migration source RAID group, before the years of use of the RAID group reaches the target life. In the chunk migration processing, it is assumed that write occurs from the host 2 to each chunk with the same level of write frequency as before (in other words, a write rate of “WR request amount 556÷years of use of RAID group 660”). In this case;

total sum of WR request amount 556 of all chunks in migration source RAID group÷years of use of RAID group×(target life−years of use of RAID group)

should be set equal to or smaller than the following:

new amount of WR per year×(target life−years of use of RAID group).

Therefore, in the chunk migration processing, the data in a few chunks is migrated to a different RAID group (migration destination RAID group) to suppress receiving data write that exceeds the predicted remaining amount of WR.

Furthermore, it may be possible that the amount of write data (or write frequency) to a RAID group is increased by having the chunk having its data migrated mapped to a different virtual chunk. However, the life prediction processing described above is executed periodically. Therefore, when the amount of write data (write frequency) to a RAID group is increased and the life of the RAID group is predicted to be shorter than the target service life (target life), chunk migration processing is performed again, and the data write exceeding the predicted remaining amount of WR is suppressed.

The preferred embodiments of the present invention have been described above, but they are mere examples illustrated to help understand the present invention, and they are not intended to restrict the scope of the present invention to the illustrated examples. The present invention can be implemented in other various forms.

For example, in the embodiment described above, a method for determining the data migration amount based on the write accumulation amount (total amount of data that the storage controller has written to the FMPK) has been described. However, in a storage device using a flash memory as the storage media, a so-called reclamation processing and the like is executed, so the amount of data written by the FMPK controller 200 to the FM chips 210 becomes greater than the amount of write data that the FMPK receives from the storage controller. This phenomenon is called WA (Write Amplification). Therefore, it is possible to have the FMPK controller 200 determine the data migration amount based on the total amount of data written by the FMPK controller 200 to the FM chips 210, instead of the write accumulation amount. Thus, the amount of data to be migrated can be calculated more accurately.

Furthermore, in write processing, when allocating a chunk to a virtual chunk, it is possible to have the chunk belonging to a RAID group having a long remaining life (remaining life of RAID group 659) allocated with priority to the virtual chunk. Thereby, it becomes possible to suppress write frequency to a RAID group having a short remaining life.

### REFERENCE SIGNS LIST

1: Storage apparatus
2: Host
3: SAN
10: Storage controller
11: Processor (CPU)
12: Host I/F
13: Disk I/F
14: Memory
15: Management I/F
16: Internal switch
20: FMPK
25: HDD
30: RAID group
31: Chunk
40: Virtual volume
41: Virtual chunk
200: FMPK controller
201: CPU
202: FMPK I/F
203: FM chip I/F
204: Memory
205: Internal switch
210: FM chip

1. A storage system having a storage controller connected to a host computer, and a plurality of storage devices connected to the storage controller, the storage system configuring a plurality of RAID groups using the plurality of storage devices;
each storage device having a nonvolatile storage media and a device controller; wherein
the device controller calculates a degradation level of the storage device based on an error bit count detected when reading a storage area of the nonvolatile storage media, and transmits the degradation level to the storage controller;
the storage controller calculates a life of the RAID group to which the storage device belongs based on the degradation level received from the storage device; and
the storage controller further specifies the RAID group whose life is shorter than a target life determined in advance, and migrates data within the specified RAID group to a different RAID group.

2. The storage system according to claim 1, wherein
when migrating data within the specified RAID group to the different RAID group, the storage controller calculates an upper limit value of the amount of write data capable of being accepted before a term of use of the specified RAID group reaches the target life, and based on the calculated upper limit value, determines the amount of data to be migrated.

3. The storage system according to claim 1, wherein
the storage controller determines the life of the storage device having the shortest life out of the plurality of storage devices belonging to the RAID group as the life of the RAID group.

4. The storage system according to claim 1, wherein
the device controller is configured to stop use of a storage area when an error bit count detected from the storage area of the nonvolatile storage media exceeds an error bit threshold; and
the device controller calculates the degradation level by dividing the error bit count by the error bit threshold.

5. The storage system according to claim 4, wherein
the error bit threshold is a value that depends on an elapsed time from when write has last been performed to the storage area.

6. The storage system according to claim 1, wherein
the storage controller has one or more pools for managing a plurality of the RAID groups; and
when migrating the data within the specified RAID group, the storage controller determines the RAID group belonging to the same pool as the specified RAID group as the migration destination of the data.

7. The storage system according to claim 6, wherein
if the life of RAID groups belonging to the same pool as the specified RAID group are all shorter than the target life, the storage controller determines a spare RAID group that does not belong to the pool as the migration destination of the data.

8. The storage system according to claim 5, wherein
the storage controller is configured to provide a plurality of virtual volumes composed of a plurality of virtual chunks to the host computer, and to map a chunk which is a storage area of the RAID group to the virtual chunk when a write request to the virtual chunk is received from the host computer; and
when migrating data within the specified RAID group, the storage controller determines the RAID group having the chunk not mapped to any of the virtual chunks as the migration destination of the data.

9. A method for controlling a storage system having a plurality of storage devices with a nonvolatile storage media and a device controller, and a storage controller connected to the plurality of storage devices and configuring a plurality of RAID groups from the plurality of storage devices; the method comprising:
the device controller calculating a degradation level of the storage device based on an error bit count detected when reading a storage area of the nonvolatile storage media, and transmitting the same to the storage controller;
the storage controller calculating a life of the RAID group to which the storage device belongs based on the degradation level received from the storage device; and
the storage controller further specifying the RAID group whose life is shorter than a target life determined in advance, and migrating data within the specified RAID group to a different RAID group.

10. The method for controlling the storage system according to claim 9, wherein
when migrating data within the specified RAID group to the different RAID group, the storage controller calculates an upper limit value of the amount of write data capable of being accepted before a term of use of the specified RAID group reaches the target life, and based on the calculated upper limit value, determines the amount of data to be migrated.

11. The method for controlling the storage system according to claim 9, wherein
the storage controller determines the life of the storage device having the shortest life out of the plurality of storage devices belonging to the RAID group as the life of the RAID group.

12. The method for controlling the storage system according to claim 9, wherein
the device controller is configured to stop use of a storage area when an error bit count detected from the storage area of the nonvolatile storage media exceeds an error bit threshold; and
the device controller calculates the degradation level by dividing the error bit count by the error bit threshold.

13. The method for controlling the storage system according to claim 12, wherein
the error bit threshold is a value that depends on an elapsed time from when write has last been performed to the storage area.
